(19) United States
(12) Patent Application Publication
(10) Pub. No.: US 2026/0363247 A1
(43) Pub. Date: Nov. 19, 2026

(54) CROP NUTRITION COMPOSITION

(71) Applicant: Komal BHUKHANWALA, Mumbai (IN)

(72) Inventor: Komal BHUKHANWALA, Mumbai (IN)

(21) Appl. No.: 19/126,204

(22) PCT Filed: Nov. 6, 2023
(86) PCT No.: PCT/IN2023/051021

§ 371 Date: Apr. 30, 2025

(30) Foreign Application Priority Data
Nov. 4, 2022 (IN) 202221063213

(51) Int. Cl. A01N 59/06; A01N 25/14; A01N 25/30; A01N 59/00; A01N 59/16; A01P 21/00

(52) U.S. Cl. CPC A01N 59/06; A01N 25/14; A01N 25/30; A01N 59/00; A01N 59/16; A01P 21/00

(57) ABSTRACT

The present invention relates to a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein composition has elemental Magnesium content in the range of 1% to 50% by weight of the total composition, and
   wherein composition has elemental Potassium content in range of 1% to 50% by weight of the total composition, and
   wherein the surfactant is in the range of 0.1 to 40% by weight of the total composition, and
   wherein composition comprises particles in size range of 0.1 to 30 microns.

The present invention further relates to a method of treating plants and meeting their nutritional requirement by making essential nutrients Magnesium, Potassium available to them.

### 1. FIELD OF THE INVENTION

The present invention relates to a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein the composition has elemental Magnesium content in the range of 1% to 50% by weight of the total composition, and
   wherein the composition has elemental Potassium content in the range of 1% to 50% by weight of the total composition. The composition of the present invention comprises particles in the size range of 0.1 micron to 30 microns. According to a further embodiment, the surfactant is in the range of 0.1 to 40% by weight of the total composition.

The present invention also relates to a method for improving plant health or enhancing the uptake of nutrient by the plants or plant yield; wherein the method comprises treating at least one of a plant, a plant propagation material, locus or plant parts thereof, a seed, seedling or surrounding soil with the crop nutrition composition of the present invention.

The present invention furthermore relates to a method of treating plants and meeting their nutritional requirement by making essential nutrients like Magnesium, Potassium available to them and also unlocking other micronutrients and trace elements present in the soil which hitherto were not available because of various factors primarily being soil degradation or antagonism between the nutrients on account of excessive use of synthetic fertilizers.

### 2. BACKGROUND OF THE INVENTION

In describing the embodiments of the invention, specific terminology is chosen for the sake of clarity. However, it is not intended that the invention be limited to the specific terms so selected and it is to be understood that each specific term includes all technical equivalents that operate in a similar manner to accomplish a similar purpose.

Nutrition is the key element in the growth, reproduction and development of crops. Nutrients play an important role in balancing crop nutrition. Poor and inadequate availability of nutrients to the plants results in a lack of proper growth and physiological development. As a consequence, the plants become more susceptible to attack by pests. Other problems associated with agriculture are environmental conditions such as drought, biotic and abiotic stress, poor soil condition, or depletion of nutrients in the soil also lead to reduction in the yield and quality of produce.

It is also known that optimum levels of nutrients are required for the normal functioning, and growth of the plants, and any variance in the nutrient levels may cause hindrance in overall crop growth and cause its health to decline due to either a deficiency or toxicity which in turn affects the nutrients essential for human diet. Furthermore, poor availability of nutrients to the plants also results in a lack of proper growth, resulting in the plants becoming more susceptible to attack by pests.

In addition to this, the interaction among different types of plant nutrients can either be antagonistic or synergistic depending upon the mixture of elements/nutrients and its composition, concentration etc. and that may influence nutrient use efficiency. Adequate supply of nutrients with optimum combination of various nutrients promotes the overall development of the crops. Due to the application of excess nutrients, plants may suffer from “nutrient antagonism” whereby an excess of a particular element may block the absorption of another element required by the plant which can result into the deficiencies in the plant.

Thus, providing adequate and balanced nutrition in a manner such that there is maximum uptake of nutrients by the plant, along with protection to the crops remains a great challenge.

Further, optimizing the soil condition and managing the use of crop nutrients has been a long-felt need for farmers to improve the nutrient use efficiency of crops. Significant research is being carried out so as to improve soil and plant health, provide better economic returns to farmers, and reduce the burden on the environment because of rampant use of synthetic pesticides.

Potassium (K) and Magnesium (Mg) are one of the essential nutrients required for balanced nutrition, and regulating biochemical functions in plants. Potassium, one of the essential macro-nutrients for which plants have the highest demand, plays a vital role in plant growth and development. It is an indispensable constituent for the correct development of plants and is essential for enzyme activation, protein synthesis, photosynthesis, osmoregulation, stomatal movement, energy transfer, phloem transport, cation-anion balance, and stress resistance. Magnesium (Mg) is an essential macro element that is also necessary for plant growth, health and development. Magnesium is involved in several different processes, including photosynthesis. The most important role of Magnesium is as a central atom or heart in the chlorophyll molecule. Without Magnesium, chlorophyll cannot capture Sun's energy required for photosynthesis. Magnesium also helps to activate specific enzyme system which are involved in a plant's normal metabolism. Furthermore, it is also needed for cell division and protein formation and is an essential component for plant respiration.

The availability of Magnesium and Potassium in the soil depends on multiple factors. One of them is the source rock material, mobility in soil, the degree of weathering, local climate and specific agricultural system, its management practices, such as crop type, cropping intensity, cropping rotation and fertilization practices. Though the benefits of Potassium and Magnesium are well known, their deficiency has become widespread over the past several decades in most of the agricultural areas of the world resulting in these nutrients being indicated as a limiting factor for improving plant growth, high yield and fertilizer efficiency. Table A discusses the impact of deficiency of Magnesium and Potassium in plants.

TABLE A
Impact of deficiency of Magnesium and Potassium in plants.

| Nutrient | Impact of deficiency in plants |
|---|---|
| Potassium | Chlorosis |
| | Wilting and scorching of older leaves |
| | Poor quality of fruits and seeds |
| | Purple spots on leaf undersides |
| | Distorted and small sized leaves |
| | Reduced flowering and branching |
| | Reduction in carbohydrate, protein |
| | and chlorophyll formation |
| | Poor resistance to ecological changes |
| Magnesium | Chlorosis of leaves |
| | Stunted growth of plants |
| | Poor quality of fruits |
| | Death of plants |

Therefore, proper nutrition is critical for optimizing the plant nutrition and metabolism, which in turn contributes to the overall crop yield, quality and nutrient rich human diet.

Chemical fertilizers based on Nitrogen, Phosphorous and Potassium (NPK) are usually employed at very high dosages in order to meet the nutritional demands of the plant. For instance: Potassium Chloride i.e. muriate of potash (MOP) has been the primary source of potassium in these conventional NPK fertilizers. However, excessive and indiscriminate application of Potassium Chloride leads to the accumulation of chloride ions in the soil which further leads to soil salinity causing damage to the plants and other micro-organisms present in the soil. Chloride affects plants primarily through increasing the osmotic potential of soil water. In other words, chloride salts increase the soil salinity which interferes with a plant's ability to take up water.

Also, with an increased rate of Ammonium Sulphate addition, the plants have become increasingly deficient in magnesium. The detrimental direct effect of ammonium sulphate on the magnesium supply to the plants was assumed to be due to a competitive effect of NH4 and H-ions on Mg-uptake. These ions are formed in great excess in the root tissues soon after the absorption of the NH4-ions. (Nitrogen-Magnesium Relationships in Crop Plants by E. G. Mulder*, Agricultural Experiment Station and Institute for Soil Research T.N.O., Groningen, The Netherlands).

Magnesium has been known to be applied to the soil in the form of water-soluble salts such as Magnesium Sulphate which has been the primary source of Magnesium in conventional nutrient fertilizers. The farmer's practices involve application of Magnesium fertilizers at very high dosage of applications. However, it tends to leach away during rains leading to low availability of Magnesium in soil for uptake of plants. Besides, the application of water-soluble Magnesium Sulphate in higher dosages significantly elevates the salinity of the soil, causing damage to the plants and other micro-organisms present in the soil.

Thus, since Magnesium and Potassium are directly and indirectly involved in numerous physiological processes associated with the growth and development of plants, it is essential to develop a composition that would adequately supply of these nutrients together. The excessive amounts of Nitrogen, Phosphorous and Calcium, in the soil further lead to a nutrient imbalance and the final produce is devoid of essential nutrients.

On account of high application of NPK fertilizers, Potassium gets accumulated in the soil which leads to an antagonistic effect on the uptake of other nutrients such as Magnesium and Calcium i.e. it inhibits the uptake of Magnesium or Calcium by plants, leading to deficiency of these nutrients in plants.

It is also known that one sided oversupply of potassium inhibits the uptake of magnesium, resulting in K—Mg antagonism. Antagonistic interactions/competitive nature of potassium and magnesium has been reported (K. L. Kabu et. al, Influence of potassium-magnesium antagonism on tomato Plant growth, Can. J. Plant Sci. 50: 711-715 (November 1970)). The soils with high-Potassium fertilization can decrease the availability of Magnesium to the plant, and may result in Magnesium deficiency of crops grown on soils that are already low in Magnesium. Conversely, crops grown on soils high in Magnesium can suffer Potassium deficiency, especially if the soils are high in Phosphorus and low in Potassium.

Thus, knowing the antagonism between magnesium and potassium, it has always been challenging to develop an agricultural composition that would not only overcome this issue in terms of increasing the uptake of Magnesium but simultaneously also maintain the pH of the soil and successfully meet the nutritional requirements of both Potassium and Magnesium in plants, which ultimately affects human nutrition.

Conventionally, micronutrient-based compositions are also known in the art in the form of bentonite granules or pastilles, pellets/prills, granules prepared through molten process etc. Such products of micronutrient compositions in the form of granules or pellets or pastilles comprise swelling clays and have been associated with several drawbacks. These compositions are generally bigger in size and include swelling clay which swells on contact with moisture and disintegrates into large particles of uneven size. Such granules or pastilles also lead to an irregular release of the micronutrients not meeting the plant's nutritional requirement and eventually resulting in poor field efficacy.

Furthermore, the patent application no. US20170283334A1 discloses a micronutrient composition comprising a combination of water insoluble and soluble micronutrients contained within a hydrated polyelectrolyte solution. The polyelectrolytes of such composition physically crosslink to create a thick, gel-like matrix in which the solid micronutrients are dispersed. Such compositions intend to deliver both immediate and sustained release of active components with the aid of a polyelectrolyte and a metal complexing agent. However, these highly concentrated formulations are difficult to dilute in water and do not form a stable dispersion and tend to form a hard pack, thus rendering them unsuitable for use. Such viscous, large particle size formulations being un-pourable tend to clog the nozzles and pose a problem in the delivery of nutrients to the plant or crop.

There are commercial compositions known in the art in the form of powders that involve either the use of water-soluble sources of nutrients or comprises of ore having the presence of both Potassium and Magnesium together. However, it was observed that such compositions tend to wash away and fail to be absorbed by the plants which in turn causes ground water contamination during heavy rainfall or irrigation. As soils become more saline, plants are unable to draw as much water and nutrients from the soil. This results not only in a marked loss of efficiency but also has serious environmental consequences. Further, powder compositions not only have the issues with respect to a practical application like the generation of dust but also pose risk to the users mostly because of eye irritation, inhalation risk and skin irritation. Such formulations are also not easily dispersible and tend to clog the nozzles when applied via drip, making it unsuitable for use in irrigation system. Further, these compositions have also been found to have poor suspensibility which lead to random and non-uniform distribution of active ingredient on the target area which would cause undesirable effects and pose a problem in effective delivery of nutrients to the plant or crop, leading to poor uptake of the nutrition by the plants. Owing to such issues, these compositions are also required to be used in very large amounts.

There also exists a disclosure of combination of Magnesium and Potassium fertilizers formulated into disaggregable or disintegrable granular composition for soil application which disintegrates or crumbles when soaked in water or when in contact with soil moisture. These types of granules are hard granules that avoid the drawbacks like generating dusts during application and also do not crumble or lose resistance during storage, transport, handling and application. For instance: WO2021250221 describes Potassium-Magnesium granular fertilizers with a good wear resistance and made by compaction or granulation based on size enlargement through wet tumbling granulation. The compositions described herein are hard in nature and designed to disintegrate or break into larger particles to release the actives in a sustained release manner when applied to soil in the presence of water. As a consequence, the actives are released very slowly making the actives remain locked in the soil for a prolonged period of time and thus fail to provide the nutrients for quick availability for uptake by the plants depriving the plant of their immediate nutritional requirement. As a consequence of the nutritional deficiency in the plants during their infancy, it makes them susceptible to various diseases eventually stunting their growth and yield. Such water disintegrable granular compositions owing to non-uniform disintegration and distribution of particles suffer from their own set of drawbacks. On account of disintegration into random, larger and non-uniform particles size, these compositions tend to clog the nozzles when applied via drip, making it unsuitable for use in modem day irrigation systems like drip irrigation.

There is a need to develop a composition comprising Magnesium in combination with Potassium which would make the said nutrients quickly available to the plant in effective quantities thus meeting the balanced nutritional requirement of plants and addressing the drawbacks associated with prior known compositions. Further, there is a need for an agricultural product that would provide high field efficacy while being applied at a reduced dosage of application of the composition.

The present inventors surprisingly found that the composition of the present invention comprising water insoluble salt of Magnesium and water soluble salt of Potassium in the form of water dispersible granules (WDG) or aqueous suspension (SC) with specific particle size was not only effective in overcoming the antagonism amongst these nutrients but also exhibited synergistic effect.

It was further noted that the enhanced effects in terms of crop yield and uptake of nutrients and growth characteristic were observed when the composition comprised of water soluble salts or derivatives of Potassium and water insoluble salts or derivatives of Magnesium and formulated into a water dispersible granules or aqueous suspension wherein the composition readily disperses in water or in the presence of soil moisture into fine particles of size range 0.1-30 microns making an immediate availability of nutrients to the plant rhizosphere.

The present composition was further observed to prevent the leaching of these nutrients and making them available to the fullest extent for the uptake by crops and increase the overall yield.

It was also observed that the composition of the present invention when formulated at a particle size of 0.1 to 30 microns further enhances the availability of nutrients Magnesium and Potassium for uptake by the plants. The present composition was also found to play a vital role in regulating soil pH and facilitate the uptake of other nutrients which are trapped in soil by plants because of various factors primarily being soil degradation or antagonism between the nutrients on account excessive use of synthetic fertilizers.

It was further surprisingly noted by the inventors that the present composition also addresses the unavailability of Magnesium which was on account of excess Potassium present in the soil due to the long-term application of NPK fertilizers and thus made magnesium quickly available for uptake.

The present composition acts as a nutrient-use efficient composition while meeting the need of crops by providing a multi nutritive solution with improved uptake by crops in a single application.

The inventors of the present application have determined that the crop nutrition composition in the form of water dispersible granules or aqueous suspension comprising one or more of water insoluble Magnesium salts or derivatives thereof and one or more of water soluble Potassium salts or derivatives thereof with one or more of surfactant; wherein the composition comprises particles in the size range of 0.1 micron to 30 microns, demonstrates excellent field efficacy even when applied at reduced dosage of application as compared to individual applications of said actives or commercially available products.

### SUMMARY OF THE INVENTION

The present invention relates to a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein the composition has elemental Magnesium content in the range of 1% to 50% by weight of the total composition, and
   wherein the composition has elemental Potassium content in the range of 1% to 50% by weight of the total composition, and
   wherein the surfactant is in the range of 0.1 to 40% by weight of the total composition, and
   wherein the composition comprises particles in the size range of 0.1 micron-30 microns.

The crop nutrition composition of the present invention in the form of water dispersible granules or aqueous suspension makes the nutrients Magnesium and Potassium available for quick uptake by the plants resulting in an increased yield in various crops and improvement of plant physiological parameters. It was further surprisingly observed that the composition of the present invention provides a balanced uptake of all nutrients including Potassium and Magnesium, thus overcoming the challenge of providing a nutrient rich crop. The present composition also addresses the unavailability of Magnesium on account of excess Potassium present due to the long-term application of NPK fertilizers in the soil.

The crop nutrition composition of the present invention is in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein the composition has elemental Magnesium content in the range of 1% to 50% by weight of the total composition, and
   wherein the composition has elemental Potassium content in the range of 1% to 50% by weight of the total composition, and
   wherein the surfactant is in the range of 0.1 to 40% by weight of the total composition, and
   wherein the composition comprises particles in the size range of 0.1 micron-30 microns.

Furthermore, the invention relates to a process for preparing a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein the composition has elemental Magnesium content in the range of 1% to 50% by weight of the total composition, and
   wherein the composition has elemental Potassium content in the range of 1% to 50% by weight of the total composition, and
   wherein the surfactant is in the range of 0.1 to 40% by weight of the total composition; and
   wherein the composition comprises particles in the size range of 0.1 micron-30 microns.

The present invention further relates to a method of treating plants and meeting their nutritional requirement by making essential nutrients like Magnesium and Potassium available to them.

The present invention relates to a method for improving plant health or enhancing the uptake of nutrient by the plants or plant yield; wherein the method comprises treating at least one of a plant, a plant propagation material, locus or plant parts thereof, a seed, seedling or surrounding soil with the crop nutrition composition of the present invention.

The present composition was also found to play a vital role in regulating soil pH and facilitating the uptake of other nutrients that are trapped in soil by plants because of various factors primarily being soil degradation on account of excessive use of synthetic fertilizers.

It was further surprising to observe that the use of this composition results in a more balanced uptake of all nutrients, leading to a healthier plant, higher nutrient harvest in all types of soils and improved soil health. The present composition acts as a nutrient use efficient composition while meeting the need of crops by providing a multi nutritive solution with improved uptake by crops.

The superior effect of the present composition is on account of combination of elements being a combination of water soluble K salt and water insoluble Mg salt formulated in WDG, SC compositions and having a particle size of 0.1-30 microns.

The present invention also relates to a method of biofortification of plant with essential micronutrients.

### BRIEF DESCRIPTION OF THE DRAWINGS

For a more complete understanding of the invention, reference is made to the embodiments illustrated in greater detail in the accompanying drawings and described by way of embodiments of the invention.

FIG. 1 illustrates an image of the water disintegrable granular composition as per the teachings of WO2021250221. The image depicts hard nature of these granules.

FIG. 2 illustrates an image of the water dispersible granular composition as per an embodiment of the present invention.

FIG. 3a illustrates an image of the prior art water disintegrable granules in water, right after initial application (30 seconds) which reflects the settling behaviour of the composition owing to disadvantages such as poor dispersion and suspensibility in water. It was observed that the water disintegrable granules on account of their physical property tend to disintegrate into larger particles and settle or sediment at the bottom of the cylinder, leaving behind a significant residue that results in non-uniform suspension and therefore non-uniform distribution or coverage of the actives on the crops, resulting in poor uptake of the nutrients by the crop, thus hampering the crop quality.

FIG. 3b illustrates an image of the water dispersible granules in water as per an embodiment of the present invention, right after initial application (30 seconds). When these water dispersible granules come in contact with an aqueous medium, they disperse immediately to release the material, and remain dispersed and suspended uniformly throughout the aqueous medium over a long period of time and make the active ingredients readily available for uptake by the plants.

FIG. 4a illustrates an image of the prior art water disintegrable granules in water, after 60 minutes of application without stirring. Even after 60 minutes, the hard granules of the prior art remained settled or sedimented at the bottom of the cylinder.

FIG. 4b illustrates an image of the water dispersible granules in water as per an embodiment of the present invention, after 60 minutes of application without stirring. The composition remains suspended easily and uniformly preventing sedimentation of the actives at the bottom of the cylinder over an extended period of time thereby ensuring uniform distribution of the actives to the crops resulting in better nutrient uptake and quality of the crops and are suitable for use in drip irrigation.

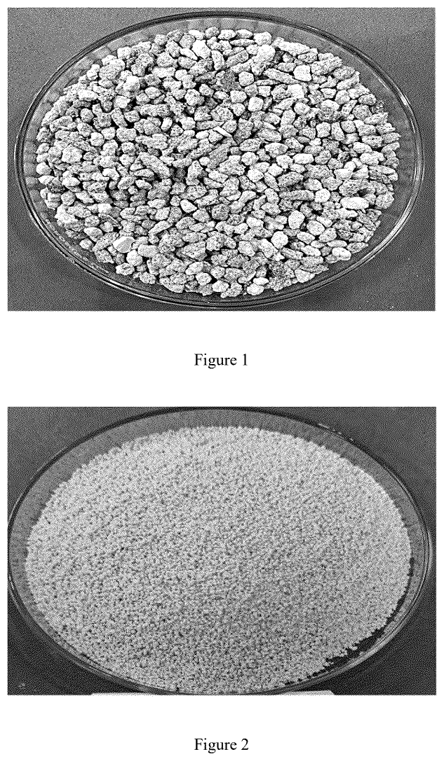

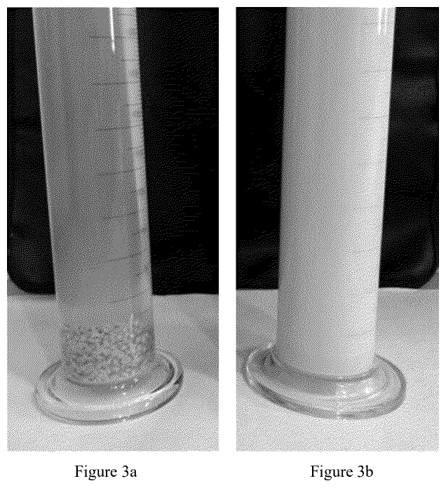

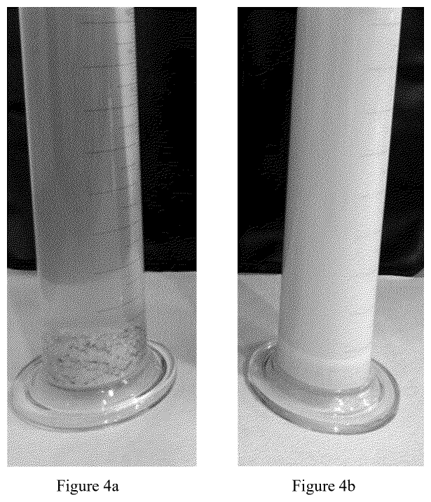

### DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all sub ranges subsumed. Also, unless denoted otherwise percentage of components in a composition are presented as weight percent or total weight of the composition.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described herein below, the phrase “comprising” may be replaced by the phrases “consisting of” or “consisting essentially of” or “consisting substantially of”. In these aspects or embodiment, the composition described includes or comprises or consists of or consists essentially of or consists substantially of the specific components recited therein, to the exclusion of other ingredients or excipients not specifically recited therein.

In some embodiments, the numbers expressing the quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Nutrient use efficiency (NUE) is defined as a measure of how well plants use the applied mineral nutrients. Improvement of NUE is an essential pre-requisite for expansion of crop production into marginal lands with low nutrient availability but also a way to reduce use of inorganic fertilizer.

The term “plant” or “crop” used in this invention are interchangeable and wherever the term “plant” has been used shall also mean vegetation of similar nature namely crops, trees, shrub, herb etc. The term ‘plant’ refers to all physical parts of a plant, including seeds, seedlings, saplings, roots, tubers, stems, stalks, foliage, and fruits. The term plant includes transgenic and non-transgenic plants.

The term “locus” of a plant herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The particle size of the composition is defined as the size of particles of the composition in the form of water dispersible granules (WG) or aqueous suspension (SC) as a whole comprising Potassium salt and Magnesium salt and excipient/s.

D50 is the corresponding particle size when the cumulative percentage reaches 50%. D50 is also called the median particle diameter or median particle size and represent an average 50% of the total particles to be smaller than the determined size.

D90 is used to indicate particle size distribution and represent average 90% of the total particles to be smaller than the determined size. D90 is also the corresponding particle size when the cumulative percentage reaches 90%.

A water dispersible granule is defined as a formulation that disperses or dissolves readily when added to water to give a fine particle suspension. As described herein, “WG” or “WDG” refer to water dispersible granules. Water-dispersible granules are formulated as small, easily measured granules (an agglomeration of fine particles) by blending and agglomerating a ground solid active ingredient together with surfactants and other formulation ingredients which disperse into finer/primary particles when immersed in water. The water-dispersible granules are obtained by spray drying or by extrusion process.

As defined herein, the term “aqueous suspension” is a composition wherein solid particles are dispersed or suspended in a water. The term “suspension concentrates” or “aqueous suspension” or “aqueous dispersion” or “an SC composition” can be used interchangeably.

“Quick release” or “instant release” or “instantaneous dispersion” can be used interchangeably and is applicable to granules which rapidly disperse to release the nutrients.

As described herein the term “water disintegrable granules” or “water disaggregable granules” refer to a granular composition comprising agglomerated granules or particles which are generally hard and possess resistance not to easily break or crumble. These granules upon contact with sufficient water or soil moisture disintegrate or break into individual particles releasing the actives over a prolonged period of time.

Further, the active dosage of Potassium and Magnesium in a composition applied in the field experiment is of elemental Potassium and elemental Magnesium.

The term ‘derivatives’ used in this invention shall also encompass the minerals or ores containing Potassium and Magnesium etc.

The term ‘salts’ used in this invention shall also encompass the compounds containing Potassium, Magnesium. The compounds of Potassium include Potassium Hydroxide and the compounds of Magnesium include Magnesium Oxide, Magnesium Hydroxide.

A mixture is defined as a combination of two or more substances that are not chemically united to each other. A homogeneous mixture is defined as one whose composition is uniform throughout the mixture. It is the type of mixture where the composition is constant throughout or the components that make up the mixture are distributed uniformly.

The present invention relates to a crop nutrition composition comprising a combination of one or more of water insoluble Magnesium salts or derivatives thereof and one or more of water soluble Potassium salts or derivatives thereof along with at least one excipient. The composition is in the form of water dispersible granules and aqueous suspension. According to an embodiment, the agrochemical excipient is a surfactant.

The crop nutrition composition is in the form of homogeneous mixture of one or more of water insoluble Magnesium salts or derivatives thereof and one or more of water soluble Potassium salts or derivatives thereof along with at least one surfactant.

According to further embodiment, the said crop nutrition composition comprises fine particles in the size range of 0.1 micron to 30 microns and exhibits improved physical properties in terms of dispersibility suspensibility, viscosity, spontaneity of dispersion, and pourability.

On account of superior physical characteristics, the composition of the present invention also finds a direct use in micro irrigation or drip irrigation systems.

The present composition has elemental Magnesium content in the range of 1% to 50% by weight of the total composition, and has elemental Potassium content in the range of 1% to 50% by weight of the total composition.

The present invention particularly relates to a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
   wherein the composition has elemental Magnesium content in the range of 1% to 50% by weight of the total composition, and
   wherein the composition has elemental Potassium content in the range of 1% to 50% by weight of the total composition, and
   wherein the surfactant is in the range of 0.1 to 40% by weight of the total composition, and
   wherein the composition comprises particles in the size range of 0.1 micron-30 microns.

It was further noted that the enhanced effects in terms of crop yield and uptake of nutrients and growth characteristic were observed when the composition comprised of water soluble salts or derivatives of Potassium and water insoluble salts or derivatives of Magnesium and formulated into a water dispersible granules or aqueous suspension wherein the composition readily disperses in water or in the presence of soil moisture into fine particles of size range 0.1-30 microns making an immediate availability of nutrients to the plant rhizosphere. The present composition also demonstrated excellent field efficacy even when applied at a reduced dosage of application.

In addition, the present composition was further observed to prevent the leaching of these nutrients and making them available to the fullest extent for the uptake by crops and increase the overall yield.

The present composition was also found to play a vital role in regulating soil pH and facilitate the uptake of other nutrients that are trapped in soil by plants because of various factors primarily being soil degradation on account excessive use of synthetic fertilizers.

It was further surprisingly noted by the inventors that the present composition also addresses the unavailability of Magnesium which was on account of excess Potassium present in the soil due to the long-term application of NPK fertilizers and thus made magnesium quickly available for uptake.

The composition of the present invention further meets the nutritional needs of plants by providing a balanced uptake of essential nutrients like Potassium and Magnesium. It was further surprising to observe that the use of this composition leads to a healthier plant that could withstand pest infestation, a higher nutrient harvest in all soil types and finally improve the overall soil health. The present composition acts as a nutrient-use efficient composition while meeting the need of crops by providing a multi nutritive solution with improved uptake by crops in a single application.

The present invention is formulated in the form of water dispersible granules (WDG or WG) or aqueous suspension (SC).

According to an embodiment, the present composition comprises water insoluble Magnesium salts or derivatives thereof; wherein elemental Magnesium content is in the range of 1% to 50% by weight of the total composition. According to an embodiment, the present composition comprises water insoluble Magnesium salts or derivatives thereof; wherein the elemental Magnesium content is in the range of 1% to 45% by weight of the total composition. According to an embodiment, the present composition comprises water insoluble Magnesium salts or derivatives thereof; wherein the elemental Magnesium content is in the range of T % to 40% by weight of the total composition. According to an embodiment, the present composition comprises water insoluble Magnesium salts or derivatives thereof; wherein the elemental Magnesium content is in the range of 2% to 50% by weight of the total composition. According to an embodiment, the present composition comprises water insoluble Magnesium salts or derivatives thereof; wherein the elemental Magnesium content is in the range of 3% to 50% by weight of the total composition. According to an embodiment, the present composition comprises water insoluble Magnesium salts or derivatives thereof; wherein the elemental Magnesium content is in the range of 4% to 50% by weight of the total composition. According to a preferred embodiment, the present composition comprises water insoluble Magnesium salts or derivatives thereof; wherein the elemental Magnesium content is in the range of 5% to 50% by weight of the total composition.

According to a further embodiment, the water-insoluble magnesium salt includes but is not limited to one or more of Magnesium Molybdate, Magnesium Hydroxide, Calcium Magnesium Phosphate, Magnesium Phosphate, Magnesium Humate, Magnesium Carbonate, Magnesium Aluminium Silicate, Calcium Magnesium Silicate, Magnesium Tartrate, Magnesium Trisilicate, Magnesium Oxalate, Magnesium Fulvate, Magnesium Silicate and Magnesium Oxide. However, those skilled in the art will appreciate that it is possible to utilize other water-insoluble salts of Magnesium without departing from the scope of the invention.

According to a further embodiment, the derivatives of water insoluble Magnesium in the composition include minerals or ores. The ores include water insoluble ores containing Magnesium but are not limited to Periclase, Brucite, Magnesite. The present invention covers the water insoluble ores of Magnesium containing Magnesium level of at least 10% selected from one or more of Periclase, Brucite, Magnesite. However, those skilled in the art will appreciate that it is possible to utilize other Magnesium containing minerals and ores without departing from the scope of the invention.

The crop nutrition composition comprises water insoluble Magnesium salts or derivatives thereof in the range of 1%-85% w/w of the total composition. The crop nutrition composition comprises Magnesium salts or derivatives thereof in the range of 3%-85% w/w of the total composition. The crop nutrition composition preferably comprises water insoluble Magnesium salts or derivatives thereof in the range of 5%-85% w/w of the total composition.

According to an embodiment, the crop nutrition composition in the form of water dispersible granules comprises water insoluble Magnesium salts or derivatives thereof in the range of 1%-85% w/w of the total composition. According to a further embodiment, the crop nutrition composition in the form of water dispersible granules comprises water insoluble Magnesium salts or derivatives thereof in the range of 3%-85% w/w of the total composition. According to a further embodiment, the crop nutrition composition in the form of water dispersible granules preferably comprises water insoluble Magnesium salts or derivatives thereof in the range of 5%-85% w/w of the total composition.

According to a preferred embodiment, the crop nutrition composition in the form of aqueous suspension comprises water insoluble Magnesium salts or derivatives thereof in the range of 1%-65% w/w of the total composition. According to further preferred embodiment, the crop nutrition composition in the form of aqueous suspension comprises water insoluble Magnesium salts or derivatives thereof in the range of 1%-60% w/w of the total composition.

According to an embodiment, the present composition comprises water soluble Potassium salt or derivatives thereof; wherein the elemental Potassium content in the present composition is in the range of 1% to 50% by weight of the total composition. According to an embodiment, the present composition comprises water soluble Potassium salts or derivatives thereof; wherein the elemental Potassium content in the present composition is in the range of 1% to 45% by weight of the total composition. According to an embodiment, the present composition comprises water soluble Potassium salts or derivatives thereof; wherein the elemental Potassium content in the present composition is in the range of 1% to 40% by weight of the total composition. According to an embodiment, the present composition comprises water soluble Potassium salt or derivatives thereof; wherein the elemental Potassium content in the present composition is in the range of 2% to 50% by weight of the total composition. According to a preferred embodiment, the present composition comprises water soluble Potassium salts or derivatives thereof; wherein the elemental Potassium content in the present composition is in the range of 3% to 50% by weight of the total composition.

According to an embodiment, the present composition in the form of water dispersible granules comprises water soluble Potassium salt or derivatives thereof; wherein the elemental Potassium content in the present composition is in the range of 1% to 50% by weight of the total composition. According to an embodiment, the present composition in the form of water dispersible granules comprises water soluble Potassium salts or derivatives thereof; wherein the elemental Potassium content in the present composition is in the range of 2% to 50% by weight of the total composition. According to a preferred embodiment, the present composition in the form of water dispersible granules comprises water soluble Potassium salts or derivatives thereof; wherein the elemental Potassium content in the present composition is in the range of 3% to 50% by weight of the total composition.

According to an embodiment, the present composition in the form of aqueous suspension comprises water soluble Potassium salt or derivatives thereof; wherein the elemental Potassium content in the present composition is in the range of 1% to 50% by weight of the total composition. According to an embodiment, the present composition in the form of aqueous suspension comprises water soluble Potassium salts or derivatives thereof; wherein the elemental Potassium content in the present composition is in the range of 1% to 30% by weight of the total composition. According to a preferred embodiment, the present composition in the form of aqueous suspension comprises water soluble Potassium salts or derivatives thereof; wherein the elemental Potassium content in the present composition is in the range of 1% to 10% by weight of the total composition.

According to a further embodiment, the water soluble Potassium salt include but are not limited to one or more of Potassium Carbonate, Potassium Selenide, Potassium Sulfate, Potassium Silicates, Potassium Hydroxide, Potassium Schoenite, Potassium Bicarbonate, Potassium Persulfate and Potassium Humate. However, those skilled in the art will appreciate that it is possible to utilize other water soluble salts of Potassium without departing from the scope of the invention.

According to an embodiment, the crop nutrition composition is devoid of Potassium Chloride.

According to a further embodiment, the derivatives of water soluble Potassium in the composition include minerals or ores. The ores include water soluble ores containing Potassium but are not limited to Camallite, Leucite, Schoenite, Picromerite, Glauconite, Biotite, Langbeinite. The present invention covers the water soluble ores of Potassium containing Potassium level of at least 4% selected from one or more of Camallite, Leucite, Schoenite, Picromerite, Glauconite, Biotite, Langbeinite. However, those skilled in the art will appreciate that it is possible to utilize other water soluble Potassium containing minerals and ores without departing from the scope of the invention.

The crop nutrition composition comprises water soluble Potassium salts or derivatives thereof in the range of 1%-85% w/w of the total composition. The crop nutrition composition comprises water soluble Potassium salts or derivatives thereof in the range of 3%-85% w/w of the total composition. The crop nutrition composition more preferably comprises water soluble Potassium salts or derivatives thereof in the range of 5%-85% w/w of the total composition.

According to an embodiment, the crop nutrition composition in the form of water dispersible granules comprises water soluble Potassium salts or derivatives thereof in the range of 1%-85% w/w of the total composition. According to a further embodiment, the crop nutrition composition in the form of water dispersible granules comprises water soluble Potassium salts or derivatives thereof in the range of 3%-85% w/w of the total composition. According to a preferred embodiment, the crop nutrition composition in the form of water dispersible granules comprises water soluble Potassium salts or derivatives thereof in the range of 5%-85% w/w of the total composition.

According to a preferred embodiment, the crop nutrition composition in the form of aqueous suspension comprises water soluble Potassium salts or derivatives thereof in the range of 1%-40% w/w of the total composition. According to a further preferred embodiment, the crop nutrition composition in the form of aqueous suspension comprises water soluble Potassium salts or derivatives thereof in the range of 1%-30% w/w of the total composition. According to a further preferred embodiment, the crop nutrition composition in the form of aqueous suspension comprises water soluble Potassium salts or derivatives thereof in the range of 1%-20% w/w of the total composition.

According to an embodiment, the present invention relates to a crop nutrition composition in the form of water dispersible granules comprising:
(i) one or more of water insoluble Magnesium salts or derivatives thereof in the range of 1%-85% w/w of the total composition,
(ii) one or more of water soluble Potassium salts or derivatives thereof in the range of 1%-85% w/w of the total composition,
(iii) one or more of surfactants selected from one or more of anionic and non-ionic surfactants,
wherein the composition has elemental Magnesium content in the range of 1% to 50% by weight of the total composition, and
wherein the composition has elemental Potassium content in the range of 1% to 50% by weight of the total composition, and
wherein the surfactant is in the range of 0.1% to 40% by weight of the total composition, and
wherein the composition comprises particles in the size range of 0.1 micron-30 microns.

According to an embodiment, the present invention relates to a crop nutrition composition in the form of aqueous suspension comprising:
(i) one or more of water insoluble Magnesium salts or derivatives thereof in the range of 1%-65% w/w of the total composition,
(ii) one or more of water soluble Potassium salts or derivatives thereof in the range of 1%-20% w/w of the total composition,
(iii) one or more of surfactants selected from one or more of anionic and non-ionic surfactants,
wherein the composition has elemental Magnesium content in the range of 1% to 50% by weight of the total composition, and
wherein the composition has elemental Potassium content in the range of 1% to 50% by weight of the total composition, and
wherein the surfactant is in the range of 0.1% to 40% by weight of the total composition, and
wherein the composition comprises particles in the size range of 0.1 micron-30 microns.

According to an embodiment, the present invention relates to a crop nutrition composition in the form of water dispersible granules or aqueous suspension comprising:
(i) one or more of water insoluble Magnesium salts or derivatives thereof in the range of 3 to 85% by weight of the total composition,
(ii) one or more of water soluble Potassium salts or derivatives thereof in the range of 3 to 85% by weight of the total composition,
(iii) one or more of surfactants in the range of 0.1% to 40% by weight of the total composition,
wherein the composition has elemental Magnesium content in the range of 1% to 50% by weight of the total composition, and
wherein the composition has elemental Potassium content in the range of 1% to 50% by weight of the total composition, and
wherein the composition comprises particles in the size range of 0.1 micron-30 microns.

According to an embodiment, the present invention relates to a crop nutrition composition in the form of water dispersible granules or aqueous suspension comprising:
(i) one or more of water insoluble Magnesium salts or derivatives thereof selected from Magnesium Molybdate, Magnesium Hydroxide, Calcium Magnesium Phosphate, Magnesium Phosphate, Magnesium Humate, Magnesium Carbonate, Magnesium Aluminium Silicate, Calcium Magnesium Silicate, Magnesium Tartrate, Magnesium Trisilicate, Magnesium Oxalate, Magnesium Fulvate, Magnesium Silicate, Magnesium Oxide, Periclase, Brucite and Magnesite,
(ii) one or more of water soluble Potassium salts or derivatives thereof selected from Potassium Carbonate, Potassium Selenide, Potassium Sulfate, Potassium Silicates, Potassium Bicarbonate, Potassium Persulfate, Potassium Hydroxide, Potassium Schoenite, Potassium Humate, Camallite, Leucite, Picromerite, Glauconite, Biotite and Langbeinite,
(iii) one or more of surfactants,
wherein the composition has elemental Magnesium content in the range of 1% to 50% by weight of the total composition, and
wherein the composition has elemental Potassium content in the range of 1% to 50% by weight of the total composition, and
wherein the surfactant is in the range of 0.1 to 40% by weight of the total composition, and
wherein the composition comprises particles in the size range of 0.1 micron-30 microns.

According to an embodiment, the crop nutrition composition in the form of water dispersible granules and aqueous suspension has a particle size of 0.1 micron to 30 microns, preferably in the range of 0.1 micron to 15 microns.

It was further observed that the present composition when formulated at a specific particle size of 0.1 micron to 30 microns, in particular 0.1 micron to 15 microns made the nutrients specifically Magnesium and Potassium readily available for uptake by the plants and increased the overall yield. Thus, the particle size range of 0.1 micron to 30 microns of the crop nutrition composition was found to be important not only in terms of ease of invention but also in terms of efficacy.

According to another embodiment, the crop nutrition composition of the present invention, in the form of water dispersible granules, comprises particles having diameter distribution of D90 of about 20 microns. According to another embodiment, the crop nutrition composition of the present invention in the form of water dispersible granules comprises particles having a diameter distribution of D90 of about 10 microns.

According to an embodiment, the crop nutrition composition is in the form of water dispersible granules, wherein the granules are in the size range of 0.05 mm to 5.0 mm. According to further embodiment, the water dispersible granules are in the size range of 0.05 mm to 3 mm. The crop nutrition composition in the form of water dispersible granules is made by various techniques such as spray drying, fluidized bed granulation, extrusion, freeze drying, spheronization etc.

According to an embodiment, the crop nutrition composition in the form of water dispersible granules, when added to water, disperse into particles in the size range of 0.1 micron to 30 microns, preferably into the particles in the size range of 0.1 micron to 15 microns.

According to an embodiment, the crop nutrition composition may further comprise at least one additional water insoluble/soluble plant nutrient.

According to an embodiment, the additional water insoluble plant nutrient is present in the range of from 0.001% to 40% by weight of the total composition.

According to further embodiment, the additional plant nutrient comprises at least one micronutrient or trace elements or its salts or derivatives thereof in the range of 0.01% to 40% by weight of the total composition by weight of the total composition.

According to still further embodiment, the micronutrient is Molybdenum (Mo); wherein Molybdenum is in its elemental form or its salts or derivatives or mixtures thereof.

According to further embodiment, the crop nutrition composition further comprises Molybdenum; wherein the composition has elemental Molybdenum content is in the range of 0.001 to 10% by weight of the total composition.

According to further embodiment, the Molybdenum salts are present in the water soluble form or water insoluble form and include but are not limited to one or more of Sodium Molybdate, Ammonium Molybdate, Molybdenum Trioxide, Molybdenite, Molybdenum Frits, Molybdenum Acetate, Molybdenum Oxide, Molybdenum Carbonate, Molybdenum Silicate, Calcium Molybdate, Molybdenum Zinc Oxide, Molybdenum Dioxide, Molybdenum Sulphide, Molybdenum Hexacarbonyl, Molybendum Telluride, Molybdenum Disulphide and Molybdenum Disilicide. According to further embodiment, Molybdenum can be in the form of elemental molybdenum or Molybdenum dust. However, those skilled in the art will appreciate that it is possible to utilize other molybdenum salts without departing from the scope of the invention.

According to a further embodiment, Molybdenum derivatives include complexes, minerals or ores of Molybdenum, but are not limited to one or more of bis(benzene)molybdenum (Mo(C6H6)2), tris(butadiene)molybdenum, Molybdenite, Wulfenite, and Chillagite. However, those skilled in the art will appreciate that it is possible to utilize other derivatives of Molybdenum without departing from the scope of the invention.

According to an embodiment, the crop nutrition composition comprises Molybdenum salts or derivatives thereof in the range of 0.001% w/w to 20% w/w of the total composition.

According to an embodiment, the crop nutrition composition is devoid of fertilizers that primarily comprise ammonium sulfate, urea or other conventional fertilizers.

According to an embodiment, the crop nutrition composition does not foresee the addition of water treatment plant sludge or is devoid of water treatment plant sludge.

The crop nutrition composition comprises one or more of agrochemically acceptable excipient selected from one or more of surfactants, fillers or carriers or diluents, spreading agents, colorants, anticaking agents, binders, buffers or pH adjusters or neutralizing agents, disintegrating agents, pigments, stabilizers, antifoaming agents or defoamers, penetrants, structuring agents, humectants, sticking agents, anti-freezing agent or freeze point depressants, chelating or complexing or sequestering agents preservatives or bactericides or anti-fungal agents or biocides or anti-microbial agents or antioxidants.

According to an embodiment, the agrochemical excipients are present in a concentration range of 0.01% to 98% by weight of the total composition. According to an embodiment, the agrochemical excipients are present in a concentration range of 0.01% to 95% by weight of the total composition.

According to an embodiment, the surfactants that are used in the crop nutrition composition include one or more of emulsifiers, wetting agents, and dispersing agents. According to an embodiment, the surfactants that are used in the composition include one or more of anionic, non-ionic, and polymeric surfactants.

The anionic surfactants include one or more of, but are not limited to a salt of Fatty Acid, a Polycarboxylate, Alkyl Ether Sulfates, an Alkyl Sulfate, an Alkylarylsulfate, an Alkylaryl Sulfonate, an Aryl Sulfonate, a Lignin Sulfonate, an Alkyl Diphenyl Ether Disulfonate, a Polystyrene Sulfonate, a Salt of Alkylphosphoric Acid Ester, an Alkylaryl Phosphate, a Styrylaryl Phosphate, a Salt Of Polyoxyethylene Alkyl Ether Sulfuric Acid Ester, Alpha Olefin Sulfonate Sodium Salt, Alkyl Benzene Sulfonate or its Salts, Sodium Lauroyl sarcosinate, Sulfosuccinates, Polyacrylates, Alkyl Ether Phosphate, a Salt of Polyoxyethylenealkylaryl Phosphoric Acid Ester, Sulfosuccinates—Mono and other Diesters, Phosphate Esters, Alkyl Naphthalene Sulfonate-Isopropyl and Butyl Derivatives, Alkyl Aryl Ether Phosphates, a salt of Polyoxyethylene Aryl Ether Phosphoric Acid Ester, Mono-Alkyl Sulphosuccinates, Aromatic Hydrocarbon Sulphonates, Ammonium Laurylsulphate, Soap, Soap Substitute, Sodium Alkyl Sulfate, Sodium Dodecyl Sulfate, Sodium Dodecyl benzenesulfonate, Sodium Laurate, Sodium Laureth sulfate, Sodium Nonanoyloxybenzenesulfonate, Alkyl Carboxylates, Sodium Stearate, Alpha Olefin Sulphonates, Naphthalene Sulfonate Salts, Alkyl Naphthalene Sulfonate Fatty Acid salts, Naphthalene Sulfonate condensates-Sodium salt, Fatty Alcohol Sulphates, Alkyl Naphthalene Sulfonate condensates-Sodium Salt, A Naphthalene Sulfonic acid Condensed with Formaldehyde or a Salt of Alkyl naphthalene Sulfonic acid condensed with Formaldehyde or salts or derivatives thereof. However, those skilled in the art will appreciate that it is possible to utilize different anionic surfactants without departing from the scope of the present invention.

The non-ionic surfactants or polymeric surfactants include one or more of but are not limited to Polyol Esters, Polyol Fatty Acid Esters, Ethoxylated and Propoxylated Fatty Alcohols, EO and PO Block Copolymers, Di, Tri-Block Copolymers, Polysorbates, Alkyl Polysaccharides, Polyoxyethylene Glycol, Sorbitan Derivatives, Fatty Acid Esters of Sorbitan (Spans) and their Ethoxylated Derivatives (Tweens), Cocamide Monoethanolamine (MEA), Decyl, Narrow-Range Ethoxylate, Oleyl Alcohol, PEG-10, Polysorbate, Polysorbate 20, Polysorbate 80, Sorbitan, Sorbitanmonolaurate, Sorbitanmonostearate, Sorbitantristearate, Stearyl Alcohol, Castor Oil Ethoxylate, Polyglycol Ethers, Polyadducts of Ethylene Oxide and Propylene Oxide, Polyoxy Ethylene Sorbitan, Fatty Acid Polyglyceride, Polyoxyethylene Alkyl Ether, Polyoxyethylenealkylaryl Ether, a Polyoxyethylenestyrylaryl Ether, a Polyoxyethylene Glycol Alkyl Ether, Alcohol Ethoxylates—C6 to C16/18 Alcohols, Linear and Branched, Alcohol Alkoxylates—various Hydrophobes and EO/PO contents and ratios, a Polyoxyethylene Hydrogenated Castor oil, salts or derivatives thereof. However, those skilled in the art will appreciate that it is possible to utilize different non-ionic surfactants or polymeric surfactants without departing from the scope of the present invention.

According to an embodiment, the surfactant is present in an amount of 0.10% to 40% w/w of the total composition. According to an embodiment, the surfactant is present in an amount of 0.1% to 30% w/w of the total composition.

According to an embodiment, the dispersing agents that are used in the crop nutrition composition include, but are not limited to non-ionic dispersants selected from one or more of polyvinyl pyrrolidone, polyvinyl alcohol, polyoxyethylene alkyl ethers, polyoxyethylene alkyl phenyl ether, ethoxylated fatty acids, aliphatic alcohol ethoxylates, alkyl ethoxylates, EO-PO block and graft copolymers; However, those skilled in the art will appreciate that it is possible to utilize different non-ionic dispersants without departing from the scope of the present invention.

According to an embodiment, the dispersing agents which are used in the crop nutrition composition include, but are not limited to anionic dispersants selected from one or more of tristyrylphenolethoxylate phosphate esters, lignin sulphonates, phenyl naphthalene sulphonates, alkali metal, alkylarylsulfonates, alkylsulfonates, mixture of sodium salt of naphthalene sulphonic acid urea formaldehyde condensate and sodium salt of phenol sulphonic formaldehyde condensate, polycarboxylates, sodium alkyl benzene sulfonates, sodium salts of sulfonated naphthalene, sodium naphthalene sulfonate formaldehyde condensates, condensation products of aryl sulphonic acids and formaldehyde, polyaromatic sulfonates, sodium alkyl aryl sulfonates and kraft lignin. However, those skilled in the art will appreciate that it is possible to utilize different anionic dispersants without departing from the scope of the present invention.

According to an embodiment, the dispersing agent is present in an amount of 0.1%-40% w/w of the total composition. According to an embodiment, the dispersing agent is present in an amount of 0.1%-30% w/w of the total composition.

According to an embodiment, the wetting agents used in the crop nutrition composition include, but are not limited to one or more of phenol naphthalene sulphonates, alkyl naphthalene sulfonate, sodium alkyl naphthalene sulfonate, naphthalene sulphonate sodium salt, dibutylnaphthalene sulfonic acid, alkylarylsulfonates, dioctyl sulfosuccinate, polyoxyethoxylated fatty alcohols, alkane sulfonates, alkylbenzene sulfonates, alkyl ether phosphates, alkyl ether sulphates and alkyl sulfosuccinic monoesters, salts or derivatives thereof. However, those skilled in the art will appreciate that it is possible to utilize different wetting agents without departing from the scope of the present invention.

According to an embodiment, the wetting agent is present in an amount of 0.1%-30% w/w of the total composition.

According to an embodiment, the carriers that are used in the crop nutrition composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention.

The solid carriers include natural minerals like clay such as china clay, acid clay, kaolin such as kaolinite, dickite, nacrite, and synthetic and diatomaceous silicas, micas, such as pyrophyllite, talc, silicas such as cristobalite and quartz, such as attapulgite and sepiolite, vermiculite, laponite, pumice, bauxite, hydrated aluminas, perlite, sodium bicarbonate, limestone, natural and synthetic silicates, silicas, surface-modified silicas, zeolite, diatomaceous earth, loess, mirabilite, white carbon, slaked lime, synthetic silicic acid, starch, modified starch, cellulose, plant carriers such as cellulose, chaff, wheat flour, wood flour, starch, rice bran, wheat bran, and soybean flour, casein sodium, sucrose, salt cake, potassium pyrophosphate, sodium tripolyphosphate or derivatives or mixtures thereof.

According to an embodiment, the carrier is present in an amount of 0.1% to 95% w/w of the composition. According to a further embodiment, the carrier is present in an amount of 0.1% to 80% w/w of the composition.

According to an embodiment, the antifoaming agents or defoamers which are used in the crop nutrition composition include but are not limited to one or more of silica, siloxane, silicone dioxide, polydimethyl siloxane, alkyl polyacrylates, ethylene oxide/propylene oxide copolymers, silicone oils and magnesium stearate or derivatives thereof. Preferred antifoaming agents include silicone emulsions, long-chain alcohols, fatty acids, fluoro-organic compounds). However, those skilled in the art will appreciate that it is possible to utilize different antifoaming agents without departing from the scope of the present invention.

According to an embodiment, the anti-foaming agent is present in an amount of 0.01% to 20% w/w of the total composition.

According to an embodiment, the pH-adjusters or buffers or neutralizing agents that are used in the composition include both acids and bases of the organic or inorganic type and mixtures thereof. According to a further embodiment, pH-adjusters or buffers or neutralizing agents include, but are not limited to one or more of organic acids, inorganic acids, and alkali metal compounds or salts, derivatives thereof.

According to an embodiment, the organic acids include, but are not limited to one or more of citric, malic, adipic, fumaric, maleic, succinic, and tartaric acids, or salts, derivatives thereof, and the mono, di, or tribasic salts of these acids or derivatives thereof. According to an embodiment, the salts of inorganic acids include, but are not limited to one or more of alkali metal salts such as, sodium chloride, sodium nitrate, potassium nitrate, sodium sulfate, potassium sulfate, sodium monohydrogen phosphate, potassium monohydrogen phosphate, sodium dihydrogen phosphate, potassium dihydrogen phosphate and the like. Mixtures can also be used to create a pH-adjusters or buffers or neutralizing agents. However, those skilled in the art will appreciate that it is possible to utilize different pH adjusters without departing from the scope of the present invention.

According to an embodiment, the pH adjuster or buffer is present in an amount of 0.01% to 20% w/w of the total composition.

According to an embodiment, the anticaking agents which are used in the crop nutrition composition include, but are not limited to one or more of polysaccharides such as fumed and precipitated silica (white carbon), ester gum, a petroleum resin, sodium stearate, polyoxyethylene (100) stearylether, sodium acetate, sodium metasilicate, sodium alkylsulfosuccinates or derivatives thereof. However, those skilled in the art will appreciate that it is possible to utilize different anticaking agents without departing from the scope of the present invention.

According to an embodiment, the anticaking agent is present in an amount of 0.1% to 20% w/w of the total composition.

According to an embodiment, the spreading agents which are used in the composition include but are not limited to one or more of copolymer of maleic acid with a styrene compound, a (meth)acrylic acid copolymer, aliphatic alcohols, vegetable oils such as cottonseed or inorganic oils, petroleum distillates, trisiloxanes and modified trisiloxanes or derivatives thereof. However, those skilled in the art will appreciate that it is possible to utilize different spreading agents without departing from the scope of the present invention.

According to an embodiment, the spreading agent is present in an amount of 0.01⁰% to 20% w/w of the total composition.

According to an embodiment, the sticking agents which are used in the composition include, but are not limited to one or more of paraffin, a polyamide resin, polyacrylate, polyoxyethylene, wax, latex, polyvinyl pyrrolidone, gums such as xanthan gum, vegetable oils such as cottonseed, or inorganic oils, petroleum distillates, modified trisiloxanes, polyglycol, a synthetic resin emulsion or salts or derivatives thereof. However, those skilled in the art will appreciate that it is possible to utilize different sticking agents without departing from the scope of the present invention.

According to an embodiment, the sticking agent is present in an amount of 0.01% to 30% w/w of the total composition.

According to an embodiment, the structuring agents that are used in the crop nutrition composition include, but are not limited to one or more of thickeners, viscosity modifiers, tackifiers, suspension aids, rheological modifiers or anti-settling agents. A structuring agent prevents sedimentation of the active ingredient particles after prolonged storage.

According to an embodiment, the structuring agents which are used in the composition include, but are not limited to one or more of polyacrylics, polysaccharides, cellulose derivatives, co-polymers of cellulose derivatives, polyvinyl alcohol and derivatives; clays such as kaolin, smectite, attapulgites and gums such as guar gum, xanthan gum, gelatin, dextrin, fumed silica, mixture of fumed silica and fumed aluminium oxide, swellable polymers, poly(ethylene glycol), stachyose, celluloses such as hemicellulose, carboxymethylcellulose, ethylcellulose, hydroxyethylcellulose, hydroxy-methyl ethyl cellulose, hydroxyl ethyl propyl cellulose, methyl hydroxyethyl cellulose, methylcellulose, plant starches such as corn starch and potato starch. However, those skilled in the art will appreciate that it is possible to utilize different structuring agents without departing from the scope of the present invention.

Preferred structuring agents include one or more of xanthan gum, aluminum silicate, Hydroxypropyl methylcellulose, carboxymethyl cellulose, methylcellulose, polysaccharide, alkaline earth metal silicate, clays, gelatin, and polyvinyl alcohol.

According to an embodiment, the structuring agent is present in an amount of 0.01% to 20% w/w of the composition. According to an embodiment, the structuring agent is present in an amount of 0.01% to 10% w/w of the composition. According to an embodiment, the structuring agent is present in an amount of 0.01% to 5% w/w of the composition. According to an embodiment, the anti-freezing agents or freezing point depressants used in the composition include, but are not limited to one or more of polyhydric alcohols such as ethylene glycol, diethylene glycol, dipropylene glycol, propylene glycol, glycerol, monohydric or polyhydric alcohols, glycol ethers, glycerol, However, those skilled in the art will appreciate that it is possible to utilize different anti-freezing agents without departing from the scope of the present invention.

According to an embodiment, the anti-freezing agent or freezing point depressant is present in an amount of 0.01% to 30% w/w of the total composition.

According to an embodiment, the chelating or complexing or sequestering agents which are used in the composition include, but are not limited to one or more of polycarboxylic acids such as polyacrylic acid and the various hydrolyzed poly(methyl vinyl ether/maleic anhydride); N-hydroxyethyliminodiacetic acid, nitrilotriacetic acid (NTA), N,N,N′,N′-ethylenediaminetetraacetic acid, N-hydroxyethyl-N, N′,N′-ethylenediaminetriacetic acid and N,N,N′,N″,N″-diethylenetriaminepentaacetic acid; α-hydroxy acids, such as citric acid, tartaric acid and gluconic acid; orthophosphates, disodium phosphate, monosodium phosphate; condensed phosphates, such as sodium tripolyphosphate, tetrasodium pyrophosphate, sodium hexametaphosphate and sodium tetrapolyphosphate; ethylene diamine tetraacetic acid (EDTA), diethylenetriaminepentaacetic acid (DTPA), N-hydroxyethyl-ethylenediamine-triacetic acid (HEDTA), ethylene diamine diacetate (EDDA), ethylene diamine di(o-hydroxyphenylacetic) acid (EDDHA), cyclohexane diamine tetraacetic acid (CDTA), fulvic acid, ulmic acid, nucleic acids, cyclodextrin, humic acid, pyrophosphate. However, those skilled in the art will appreciate that it is possible to utilize different chelating agents without departing from the scope of the present invention.

According to an embodiment, the chelating agent is present in an amount of 0.01% to 30% w/w of the total composition.

According to an embodiment, the penetrants which are used in the composition include, but are not limited to one or more of alcohol, glycol, glycol ether, ester, amine, alkanolamine, amine oxide, quaternary ammonium compound, triglyceride, fatty acid ester, fatty acid ether, N-methyl pyrrolidone, dimethyl formamide, dimethyl acetamide, or dimethyl sulfoxide, polyoxyethylenetrimethylolpropanemonooleate, polyoxyethylene sorbitan monooleate polyoxyethylenetrimethylolpropanedioleate, polyoxyethylene trimethylol propane trioleate, polyoxyethylene sorbitol hexaoleate. However, those skilled in the art will appreciate that it is possible to utilize different penetrants without departing from the scope of the present invention.

According to an embodiment, the penetrant is present in an amount of 0.01% to 30% w/w of the total composition.

According to an embodiment, the humectants are selected from, but are not limited to one or more of polyoxyethylene/polyoxypropylene copolymers, particularly block copolymers. Other humectants are propylene glycol, monoethylene glycol, hexylene glycol, butylene glycol, ethylene glycol, diethylene glycol, poly (ethylene glycol), poly (propylene glycol), glycerol and the like; polyhydric alcohol compounds such as propylene glycol ether, derivatives thereof. However, those skilled in the art will appreciate that it is possible to utilize different humectants without departing from the scope of the present invention.

According to an embodiment, the humectant is present in the range of 0.1% to 40% w/w of the total composition.

According to an embodiment, the stabilizers which are used in the agricultural composition include, but are not limited to one or more of peroxide compounds such as hydrogen peroxide and organic peroxides, zeolite, antioxidants such as phenol compounds, phosphoric acid compounds, EDTA, sodium sulphites, citric acid, citrates and the like. However, those skilled in the art will appreciate that it is possible to utilize other conventionally known stabilizers without departing from the scope of the present invention.

According to an embodiment, the stabilizer is present in the range of 1% to 30% w/w of the total composition.

According to an embodiment, preservatives are selected from one or more of formic acid, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3(2H)-one, BIT, commercially available as Proxel® types from Arch Biocides Ltd.) or 2-methyl-4,5-trimethylene-2H-isothiazol-3-one (MTIT), Proxel® or Acticide® RS and Kathon® MK, Sodium Propinoate, Sodium Benzoate, Propyl Paraben, Propyl Paraben Sodum, Potassium Sorbate, Potassium Benzoate, Phenyl Mercuric Nitrate, Phenyl Etehyl Alcohol, Sodium, Ethylparaben, Methylparaben, Butylparaben, Benzyl Alcohol, Benzothonium Chloride, Cetyl pyridinium Chloride, Antioxidants includes but are not limited to one or more of imidazole and imidazole derivatives (e.g. urocanic acid), 4,4′-thiobis-6-t-butyl-3-methylphenol, 2,6-di-t-butyl-p-cresol (BHT), penta erythrityl tetrakis[3-(3,5,-di-t-butyl-4-hydroxyphenyl)]propionate; amine antioxidants. However, those skilled in the art will appreciate that it is possible to utilize other conventionally known preservatives without departing from the scope of the present invention.

According to an embodiment, the preservative is present in the range of 0.01% to 2% w/w of the total composition.

According to an embodiment, the pigments and colorants are selected from but are not limited to synthetic chemicals obtained from various manufacturers. The pigments and colorants can be water soluble or water insoluble, in the form of lakes. Dyes can be solvent dyes, acid dyes or basic dyes. However, those skilled in the art will appreciate that it is possible to utilize other conventionally known pigments and colorants without departing from the scope of the present invention.

According to an embodiment, the pigment and colorant is present in the range of 0.01% to 5% w/w of the total composition.

According to an embodiment, the disintegrating agents which are used in the agricultural composition include, but are not limited to one or more of inorganic water soluble salts e.g. sodium chloride; water soluble organic compounds such as agar, hydroxypropyl starch, carboxymethyl starch ether, tragacanth, cross-linked sodium carboxymethyl cellulose, sodium tripolyphosphate, sodium hexametaphosphate, metal stearates, a cellulose powder, dextrin, methacrylate copolymer, Polyplasdone® XL-10 (crosslinked polyvinyl pyrrolidone), poly(vinylpyrrolidone). However, those skilled in the art will appreciate that it is possible to utilize other conventionally known disintegrating agents without departing from the scope of the present invention.

According to an embodiment, the disintegrating agent is present in the range of 0.5% to 15% w/w of the total composition.

According to an embodiment, the binding agents or binders that are used in the agricultural composition include, but are not limited to one or more of maltodextrin, carbohydrates such as monosaccharides, disaccharides, oligosaccharides and polysaccharides, complex organic substance, synthetic organic polymers or derivatives and combinations thereof. However, those skilled in the art will appreciate that it is possible to utilize other conventionally known binding agents without departing from the scope of the present invention.

According to an embodiment, the binder is present in the range of 0.10% to 10% w/w of the total composition.

The inventors have further determined that the composition of the present invention surprisingly has enhanced physical properties of dispersibility, wetting time, suspensibility, improved viscosity, pourability, and spontaneity of dispersion providing ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined.

According to an embodiment, the water dispersible granular composition of the present invention has a wettability of less than 2 minutes. According to an embodiment, the water dispersible granular composition has a wettability of less than 1 minute.

Dispersibility of the water dispersible granular composition of the present invention is determined as per the standard CIPAC test, MT 174. According to an embodiment, the water dispersible granular composition has a dispersibility of at least 30%. According to an embodiment, the water dispersible granular composition has can dispersibility of at least 50%. According to an embodiment, the water dispersible granular composition has a dispersibility of at least 70%. According to an embodiment, the water dispersible granular composition has a dispersibility of at least 90%. The composition of the present invention disperses uniformly into finer particles in the size range of 0.1 micron to 30 microns when comes in contact with water.

According to an embodiment, the crop nutrition composition in the form of water dispersible granules exhibit almost instantaneous dispersion; thus making the nutrients readily available to the crops.

According to an embodiment, the composition demonstrates a dispersibility of more than 85% under ATS. According to an embodiment, the composition demonstrates a dispersibility of more than 70% under ATS. According to an embodiment, the composition demonstrates a dispersibility of more than 50% under ATS. According to an embodiment, the composition demonstrates a dispersibility of more than 40% under ATS.

Attrition resistance determines the resistance of a granular material to wear. The water-dispersible granular composition has good attrition resistance. The Samples can be tested for attrition as per the CIPAC Handbook specified test, “MT 178.2-Attrition resistance of granules”. According to an embodiment, the attrition resistance of the dispersible granular composition is at least 50%. According to an embodiment, the attrition resistance of the dispersible granular composition is at least 80%.

According to an embodiment, the crop nutrition composition in the form of water dispersible granules or aqueous suspension passes the wet sieve retention test. The test is used to determine the amount of non-dispersible material in formulations that are applied as dispersions in water. The wet sieve retention value of the agrochemical composition in the form of aqueous suspension and granules is measured by using the Standard CIPAC Test MT-185 which describes a procedure for measuring the amount of material retained on the sieve. A sample of the formulation is dispersed in water and the suspension formed is transferred to a sieve and washed. The amount of the material retained on the sieve is determined by drying and weighing.

According to an embodiment, the crop nutrition composition in the form of water dispersible granule or aqueous suspension has a wet sieve retention value on a 75-micron sieve of less than 2%. According to an embodiment, the crop nutrition composition has a wet sieve retention value on a 75-micron sieve of less than 0.2%. The wet sieve retention value of less than 2% indicates that the crop nutrition composition helps in the easy invention of the formulation preventing clogging of the nozzles or filter equipment.

Suspensibility is defined as the amount of active ingredient suspended after a given time in a column of liquid of stated height, expressed as a percentage of the amount of active ingredient in the original suspension. The test for suspensibility is done as per the CIPAC Handbook, “MT 184 Test for Suspensibility”.

According to an embodiment, the composition of the present invention in the form of water dispersible granules or aqueous suspension has a suspensibility of at least 30%. According to an embodiment, the composition has a suspensibility of at least 60%. According to an embodiment, the composition has a suspensibility of at least 80%. According to an embodiment, the composition has a suspensibility of at least 90%.

According to an embodiment, the composition of the present invention demonstrates superior suspensibility under accelerated storage conditions (ATS). According to an embodiment, the composition demonstrates a suspensibility of more than 85% under ATS. According to an embodiment, the composition demonstrates a suspensibility of more than 60% under ATS. According to an embodiment, the composition demonstrates a suspensibility of more than 40% under ATS.

According to an embodiment, the crop nutrition composition in the form of aqueous suspension is not highly concentrated and is easily pourable. The viscosity of a fluid is a measure of its resistance to gradual deformation by shear stress or tensile stress. According to an embodiment, the viscosity of the aqueous suspension is determined as per CIPAC MT-192. A sample is transferred to a standard measuring system. The measurement is carried out under different shear conditions and the apparent viscosities are determined. During the test, the temperature of the liquid is kept constant. According to an embodiment, the aqueous suspension composition has a viscosity at 25 °C. of 150 cps to 2000 cps which makes it pourable. According to an embodiment, the aqueous suspension composition has a viscosity at 25 °C. of 200 cps to 1000 cps.

According to an embodiment, the aqueous suspension composition has a viscosity at 25 °C. of less than 2000 cps. According to an embodiment, the aqueous suspension composition has a viscosity at 25 °C. of less than 1000 cps. Too viscous and highly concentrated composition tends to form a cake making it unpourable and thus is undesirable.

According to an embodiment, the aqueous suspension composition of the invention is easily pourable. The pourability is the measure of the percent of residue.

According to an embodiment, the pourability of the composition is determined as per CIPAC MT-148.1 by allowing the composition to stand for 24 hours and the amount remaining in the container after a standardized pouring procedure is determined. The container is rinsed and the amount remaining is determined and the maximum rinsed residue in percent is calculated. According to a further embodiment, the pourability of composition is less than 5% rinsed residue. According to a further embodiment, the pourability of the composition is preferably less than 2.5% rinsed residue.

According to an embodiment, the spontaneity of dispersion is measured as per CIPAC MT 160. It involves preparing 250 ml of a mixture of formulation and water, mixed with only one inversion of the measuring cylinder. After standing under defined conditions the top nine-tenths is removed, and the remaining tenth assayed chemically, gravimetrically or by solvent extraction. The spontaneity of dispersion is readily calculated.

According to an embodiment, the suspension concentrate composition has a spontaneity of dispersion of 30%. According to an embodiment, the composition has a spontaneity of dispersion of 60%. According to an embodiment, the composition has a spontaneity of dispersion of 80%. According to an embodiment, the composition has a spontaneity of dispersion of 95%.

According to an embodiment, the composition of the present invention demonstrates superior stability towards heat, light, temperature and caking. According to an embodiment, the stability exhibited by the composition is at least 3 years. According to a further embodiment, the stability exhibited by the composition is at least 2 years. According to a further embodiment, the stability exhibited by the composition is at least 1 year. According to a further embodiment, the stability exhibited by the composition is at least 6 months.

According to an embodiment, the crop nutrition composition in the form of water dispersible granules has hardness of less than 4 Newtons. According to further embodiment, the crop nutrition composition in the form of water dispersible granules has hardness of less than 3 Newtons. According to further embodiment, the crop nutrition composition in the form of water dispersible granules has hardness of less than 2 Newtons. According to further embodiment, the crop nutrition composition in the form of water dispersible granules has hardness of less than 1 Newtons.

More preferably, the crop nutrition composition in the form of water dispersible granules has a nil hardness. The reference to nil hardness is indicative of the fact that the hardness of the granules cannot be measured by the hardness measuring apparatus. The hardness exhibited by the granules can be estimated by hardness testers such as the ones provided by Vinsyst Portable Table Hardness Tester VTHT series.

According to an embodiment, the present invention relates to a process for preparing a crop nutrition composition in the form of water dispersible granules or aqueous suspension comprising:
(i) one or more of water insoluble Magnesium salts or derivatives thereof,
(ii) one or more of water soluble Potassium salts or derivatives thereof,
(iii) one or more of surfactants,
wherein the composition has elemental Magnesium content in the range of 1% to 50% by weight of the total composition, and
wherein the composition has elemental Potassium content in the range of 1% to 50% by weight of the total composition, and
wherein the surfactant is in the range of 0.1 to 40% by weight of the total composition, and
and wherein the composition comprises particles in the size range of 0.1 micron-30 microns.

The crop nutrition composition in the form of water dispersible granules is made by various techniques such as spray drying, fluidized bed granulation, extrusion, freeze drying, spheronization etc.

According to an embodiment, the present invention relates to a process for preparing a crop nutrition composition in the form of water dispersible granules comprising milling:
i. one or more of water insoluble Magnesium salts or derivatives thereof,
ii. one or more of water soluble Potassium salts or derivatives thereof,
iii. one or more of surfactant,
   in water to obtain a slurry or wet mix. The slurry or wet mix obtained is then dried for instance in a spray dryer, fluid bed dryer, or any suitable granulating equipment to obtain water dispersible granules comprising particles in the size range of 0.1 micron-30 microns; and
   wherein the composition has elemental Magnesium content in the range of 1% to 50% by weight of the total composition, and
   wherein the composition has elemental Potassium content in the range of 1% to 50% by weight of the total composition and
   wherein the surfactant is in the range of 0.1 to 40% by weight of the total composition.

The water dispersible granules are further sieved to remove the undersized and oversized granules and obtain the desired size.

According to another embodiment, the crop nutrition composition in the form of water dispersible granules is also made by dry milling of:
i. one or more of water insoluble Magnesium salts or derivatives thereof,
ii. one or more of water soluble Potassium salts or derivatives thereof,
iii. one or more of surfactant,
in an air mill or a jet mill to obtain a mixture with fine particle size. Water is added to the dry powder and the mixture is blended to obtain a dough or paste or wet mix, which is then extruded through an extruder to obtain the granules comprising particles in the size range of 0.1 micron-30 microns. The water dispersible granules are further sieved to remove the undersized and oversized granules and obtain the desired size.

According to an embodiment, the process for preparation of the crop nutrition composition in the form of aqueous suspension comprises: milling:
i. one or more of water insoluble Magnesium salts or derivatives thereof,
ii. one or more of water soluble Potassium salts or derivatives thereof,
iii. one or more of surfactants, in water to obtain a homogeneous suspension with a particle size range of 0.1 micron to 30 microns,
   wherein the composition has elemental Magnesium content in the range of 1% to 50% by weight of the total composition and
   wherein the composition has elemental Potassium content in the range of 1% to 50% by weight of the total composition, and
   wherein the surfactant is in the range of 0.1 to 40% by weight of the total composition.

According to an embodiment, the process of preparing the aqueous suspension composition involves the homogenization of one or more of surfactants in water by feeding them into a vessel provided with stirring facilities. One or more of water insoluble Magnesium salts or derivatives thereof and one or more of water soluble Potassium salts or derivatives thereof are added to the homogenized blend and stirred continuously for about 5 to 10 minutes until the total mixture becomes homogeneous. Subsequently, the suspension obtained is passed through the wet mill to obtain a particle size in the range of 0.1 to 30 microns, preferably 0.1 to 10 microns. If required, one or more of excipients such as structuring agent or optionally biocide or preservatives are added to the obtained suspension, under continuous homogenization.

According to an embodiment, the invention further relates to the use of the crop nutrition composition as at least one of a nutrient composition, a crop strengthener composition, a soil conditioner composition, crop protection and a yield enhancer composition.

The present invention relates to a method for improving plant health or enhancing the uptake of nutrients by the plants or plant yield; wherein the method comprises treating at least one of a plant, a plant propagation material, locus or plant parts thereof, a seed, seedling or surrounding soil with the crop nutrition composition of the present invention.

The present invention further relates to a method of treating plants and meeting their nutritional requirement by making essential nutrients like Magnesium, Potassium available to them and also unlocking other micronutrients and trace elements present in the soil which hitherto were not available because of various factors primarily being soil degradation on account of excessive use of synthetic fertilizers.

The present invention also relates to a method of biofortification of plant with essential micronutrients.

The present composition can be applied through a variety of methods. Methods of applying to the soil includes any suitable method, which ensures that the composition penetrates the soil for example nursery tray application, in furrow application, drip irrigation, sprinkler irrigation, soil drenching, soil injection or incorporation into the soil and such other methods. The composition also can be applied in the form of a foliar spray.

The present composition was further observed to prevent the leaching of these nutrients and make them available to the fullest extent for the uptake by crops and increase the overall yield.

It was also observed that the composition of the present invention when formulated at a specific particle size further enhances the availability of nutrients Magnesium and Potassium for uptake by the plants. The present composition was also found to play a vital role in regulating soil pH and facilitate the uptake of other nutrients which are trapped in soil by plants because of various factors primarily being soil degradation or antagonism between the nutrients on account of excessive use of synthetic fertilizers.

It was further surprisingly noted by the inventors that the present composition also addresses the unavailability of Magnesium which was on account of excess Potassium present in the soil due to the long-term application of NPK fertilizers and thus made magnesium quickly available for uptake.

The composition of the present invention met the nutritional needs of plants by providing a balanced uptake of essential nutrients like Potassium and Magnesium. It was further surprising to observe that the use of this composition leads to a healthier plant that could withstand pest infestation, a higher nutrient harvest in all soils types and finally improve the overall soil health. The present composition acts as a nutrient-use efficient composition while meeting the need of crops by providing a multi nutritive solution with improved uptake by crops in a single application.

The rates of invention or the dosage of the composition depends on the type of use, the type of crops, or the specific active ingredients in the composition but is such that the active ingredient, is in an effective amount to provide the desired action such as crop protection, crop yield and nutrient uptake.

### A. Preparation Examples:

The following examples illustrate the basic methodology and versatility of the composition of the invention. The water insoluble salts or derivatives of Magnesium and water soluble salts or derivatives of Potassium exemplified in the preparatory examples can be replaced by any other water insoluble salts or derivatives of Magnesium and any other water soluble sources of Potassium as covered in the present specification varying the covered concentration ranges respectively. The form of the composition, excipients and concentrations of the actives & excipients used in these examples can be replaced by other forms, excipients and concentrations of the actives & excipients as covered in the present invention. It should be noted that this invention is not limited to these exemplifications.

### A. Water Dispersible Granular Composition:

1. Water dispersible granular composition of 18% Magnesium Hydroxide (7.50% elemental Mg) and 38% Potassium Carbonate (21.35% elemental K)

Water dispersible granular composition was prepared by blending 4 parts of sodium lignosulphonate, 34 parts of sodium citrate, 18 parts of Magnesium Hydroxide, and 38 parts of Potassium Carbonate to obtain a homogeneous slurry. The slurry obtained was wet ground (with water) along with 6 parts of sodium tripolyphosphate for one hour, in suitable wet grinding equipment to get an average particle size below 2.5 microns and then spray dried to get granules.

The composition has a particle size in the range of 0.1-5 microns. The granule size of the composition is in the range of 0.05-1.5 mm. The composition has a dispersibility of 80%, suspensibility of 90.2%, wet sieve retention of 0.05% on 75 microns sieve, wettability of less than 5 sec and nil hardness. The composition further demonstrated a suspensibility of about 80% and dispersibility of 70% under accelerated storage conditions.
2. Water dispersible granular composition of 8% Magnesium Molybdate (1.05% elemental Mg) and 81% Potassium Carbonate (45.51% elemental K).

The water dispersible granular composition was prepared as per Example 1 by blending 3 parts of sodium lignosulphonate, 2 parts of the sodium salt of naphthalene sulfonate formaldehyde condensate, 1 part of a blend of salt of naphthalene sulphonic acid and phenol sulphonic acid condensation product, 8 parts of Magnesium Molybdate, 1 part of clay, 4 parts of sodium sulphate and 81 parts of Potassium Carbonate. The slurry obtained was wet ground in suitable wet grinding equipment and then spray dried/fluid bed dried to get granules.

The composition has a particle size in the range of microns 0.1 micron to 10 microns. The granule size of the composition is in the range of 0.1-2.5 mm. The composition has a dispersibility of 92%, suspensibility of 95%, wet sieve retention of 0.02% on 75 microns sieve and wettability of less than 2 sec. The composition has nil hardness. The composition further demonstrated a suspensibility of about 85% and dispersibility of 85% under accelerated storage conditions.
3. Water dispersible granular composition of 80% Magnesium Oxide (48.26% elemental Mg) and 5.5% Potassium Schoenite (1.07% elemental K).

The water dispersible granular composition was prepared as per Example 1 by blending 6 parts of sodium lignosulphonate, 4 parts of the sodium salt of naphthalene sulfonate formaldehyde condensate, 3.5 parts of a blend of salt of naphthalene sulphonic acid and phenol sulphonic acid condensation product, 1 part of sodium citrate, 80 parts of Magnesium Oxide and 5.5 parts of Potassium Schoenite. The slurry obtained was wet ground in suitable wet grinding equipment using suitable amount of water and then spray dried/fluid bed dried to get granules.

The composition has a particle size in the range of microns 0.1 micron to 20 microns. The granule size of the composition is in the range of 0.1-3.0 mm. The composition has a dispersibility of 65%, suspensibility of 70%, Wet sieve retention of 0.2% on 75 microns sieve and wettability of less than 50 sec. The composition further demonstrated a suspensibility of about 60% and dispersibility of 55% under accelerated storage conditions.
4. Water dispersible granular composition of 34% Magnesium Oxide (20.503% elemental Mg)+11% Potassium Silicate (5.575% elemental K)

The water dispersible composition was prepared as per Example 1 by blending 34 parts of Magnesium Oxide, 11 parts of Potassium Silicate, 6 parts of polycarboxylate, 6 parts of Kraft lignin polymer, 4 parts of sodium salt of naphthalene sulfonate condensate, 3 parts of sodium citrate, 3 parts of sodium lauryl sulphate and 33 parts of clay along with water and thereafter milled and dried in a suitable equipment to get granules with particle size D50 of 2.5 microns and D90 of 7 microns.

The composition has a granule size of 0.1 mm-3 mm, dispersibility of 45%, suspensibility of 50% and wettability of less than 35 sec. The composition further demonstrated suspensibility of about 40% and dispersibility of 40%, wettability of 40 seconds under accelerated storage conditions.
5. Water dispersible granular composition of 7% Calcium Magnesium Phosphate (1.068% elemental Mg)+42% Leucite (7.522% elemental K)

The water dispersible composition was prepared as per example 1 by blending 5 parts of sodium citrate, 7 parts of Calcium Magnesium Phosphate, 42 parts of Leucite, 10 parts of sodium sulphate, 5 parts of sodium lignosulphonate, 2 parts of sodium salt of naphthalene sulfonate condensate, 2 parts of sodium lauryl sulphate, 1 parts of poly carboxylate, 10 parts of lactose and 16 parts of clay along with water in a blender to obtain slurry. The slurry obtained was wet ground in suitable wet grinding equipment using suitable amount of water and then spray dried/fluid bed dried to obtain granules having size below 3.5 mm.

The composition has particle size less than 20 microns. The composition has a dispersibility of 60%, suspensibility of 65%, wet sieve retention 0.13% on 75 microns sieve and wettability of less than 55 sec. The composition further demonstrated suspensibility of about 55% and dispersibility of 50%, wettability of 1 minute under accelerated storage conditions.
6. Water dispersible granular composition of 27% Magnesium Hydroxide (11.25% elemental Mg)+30% Potassium Silicate (15.21% elemental K)+0.095% Molybdenum Disulfide (0.057% elemental Mo) The water dispersible composition was prepared as per example 1 by blending 3 parts of sodium citrate, 27 parts of Magnesium Hydroxide, 30 parts of Potassium Silicate, 0.095 parts of Molybdenum Disulfide, 7.905 parts of sodium sulphate, 9 parts of sodium lignosulphonate, 4 parts of sodium salt of naphthalene sulfonate condensate, 1 parts of sodium lauryl sulphate, 2 parts of poly carboxylate, and 16 parts of clay along with water in a blender to obtain slurry. The slurry obtained was wet ground in suitable wet grinding equipment using suitable amount of water and then spray dried to obtain granules in the size range of 0.1 mm-3 mm. The composition has particle size in the range of 0.1 micron-15 microns. The composition has a dispersibility of 85%, suspensibility of 80%, wet sieve retention 0.15% on 75 microns sieve and wettability of less than 30 sec. The composition further demonstrated suspensibility of about 70% and dispersibility of 75%, wettability of 55 minute under accelerated storage conditions.

### B. Aqueous Suspension Composition:

7. Aqueous Suspension composition of 40% Magnesium Hydroxide (16.67% elemental Mg)+10% Potassium Bicarbonate (3.91% elemental K).

50 g of Ethylene Oxide (EO)/Propylene Oxide (PO) Copolymer and 80 g of propylene glycol were added to water (quantity sufficient so as to make 1 L composition) and homogenized by feeding them into a vessel provided with stirring facilities. 400 g of Magnesium Hydroxide and 100 g of Potassium Bicarbonate were further added to the homogenized blend and stirred continuously for approximately 20 minutes until the total mixture was homogeneous. To the above mixture, 1 part of polydimethylsiloxane emulsion was added under continuous homogenization to obtain aqueous suspension. Subsequently, the suspension obtained was passed through the wet mill to reduce the particle size. Then, 1.2 g of xanthan gum, 1 g of 1,2-benzisothiazolin-3-one and 1.5 g of polydimethylsiloxane emulsion were added under continuous homogenization to obtain the aqueous suspension. The composition had a particle size of diameter distribution of D50 of 1.32 micron and D90 of 2.85 microns, viscosity of 250 cps and suspensibility of 95.2%, spontaneity of dispersion of 92% and wet sieve retention on 75 microns of 0.01%. The pourability rinsed residue was found to be 0.5%. The composition has suspensibility of 85% under accelerated storage conditions.
8. Aqueous Suspension composition of 15% Magnesium Oxalate (3.246% elemental Mg)+6% Potassium Schoenite (1.17% elemental K)

80 parts of tristyrylphenolethoxylate phosphate esters and 120 parts of monoethylene glycol were added to water (quantity sufficient so as to make 1 L composition) and homogenized by feeding them into a vessel provided with stirring facilities. 150 parts of Magnesium Oxalate and 60 parts of Potassium Schoenite were further added to the homogenized blend and stirred continuously for approximately 10 minutes until the total mixture was homogeneous. To the above mixture, 1 part of polydimethylsiloxane emulsion was added under continuous homogenization to obtain aqueous suspension. Subsequently, the suspension obtained was passed through the wet mill to reduce the particle size. Then, 1.5 part of xanthan gum, 1 part of 1,2-benzisothiazolin-3-one and 1.5 parts of polydimethylsiloxane emulsion was added under continuous homogenization to obtain the aqueous suspension.

The composition had a particle size diameter distribution of D50 of 1.52 microns and D90 of 2.75 microns, viscosity of 450 cps, spontaneity of dispersion of 93.10, wet sieve retention on 75 microns of 0.01% and suspensibility of 90.2%. The pourability rinsed residue was found to be 0.4%. The composition has suspensibility of 80% under accelerated storage conditions.
9. Aqueous Suspension composition of 25% Magnesium Oxide (15.076% elemental Mg)+3% Potassium Carbonate (1.69% elemental K)

This composition was prepared similarly to Example 6 using 40 parts of Polyethoxylated Alcohol, 50 parts of kaolin and 100 parts of monoethylene glycol, 250 parts of Magnesium Oxide, 1 parts of polydimethylsiloxane emulsion, 1 part of xanthan gum, 1 part of 1,2-benzisothiazolin-3-one, 30 parts of Potassium Carbonate and 1.5 parts of polydimethylsiloxane emulsion in water (quantity sufficient so as to make 1 L composition).

The composition had a particle size in the range of 0.1-8 microns, viscosity of 385 cps, spontaneity of dispersion of 88.10%, wet sieve retention on 75 microns of 0.05% and Suspensibility of 70%. The pourability rinsed residue was found to be 0.7%. The composition has suspensibility of 50% under accelerated storage conditions.
10. Aqueous Suspension composition of 48% Magnesium Phosphate (13.32% elemental Mg)+5% Potassium Silicate (2.53% elemental K)

This composition was prepared similarly to Example 6 using 50 parts of Polyoxyethylene Glycol, 80 parts of monoethylene glycol, 480 parts of Magnesium Phosphate, 1 part of polydimethylsiloxane emulsion, 1 part of glycerine, 1 part of 1,2-benzisothiazolin-3-one, 50 parts of Potassium Silicate and 1.5 parts of polydimethylsiloxane emulsion in water (quantity sufficient so as to make 1 L composition).

The composition had a particle size range of 0.1-3 microns, viscosity of 550 cps, spontaneity of dispersion of 81.10%, wet sieve retention on 75 microns of 0.09% and suspensibility of 70%. The pourability rinsed residue was found to be 0.8%. The composition has suspensibility of 60% under accelerated storage conditions.

### B. Field Study:

Experiment 1: To study the effect of WDG, SC compositions of “water insoluble Magnesium salt and water soluble Potassium salt” on Rice Crop:

### Field Experiment Methodology:

The field trials were carried out to evaluate the effect of embodiments of the composition of the present invention on yield of rice (paddy) at Chiloda, Gandhinagar.

The trial was laid out during Kharif season in Randomized Block Design (RBD) with eight treatments including untreated control, replicated four times. For each treatment, plot size of 40 sq·m (8m×5m) was maintained. The test products with prescribed dose were applied as top dressing at 15 days after transplanting of the paddy. The paddy crop in trial field was raised following good agricultural practice. The seeds of paddy variety Gurjari, were used for raising the nursery and 25 days old nursery was used for transplanting the trial field in 30 cm row to row and 25 cm plant to plant spacing. The active dosage of Potassium and Magnesium applied in the field experiment is of elemental Potassium (P) and elemental Magnesium (Mg).

### Details of Experiment

a) Trial Location: Chiloda, Gandinagar
b) Crop: Rice (var: Gurjari)
c) Experiment season: Kharif 2023
d) Trial Design: Randomized Block Design
e) Replications: Four
f) Treatments: 8
g) Plot size: 8m×5m=40 sq·m
h) Date of transplanting: Jun. 18, 2023
i) Date of Application: Jul. 3, 2023
j) Method of application: Top dressing
k) Date of Harvesting: Oct. 2, 2023

The observations on yield were recorded at the time of harvesting and mean data is presented in Table 1 to enumerate the efficacy of the WDG, SC compositions of “Water insoluble Magnesium (Mg) salt and water soluble Potassium (K) salt” prepared as per the embodiment of the present invention. The nutrient uptake in rice seeds was also measured by analyzing in lab.

TABLE 1

| | Active ingredient | | | % | Expected |
|---|---|---|---|---|---|
| | g/ha (Elemental) | | Yield | Increase | % yield |
| Treatment Details | K | Mg | (Kg/ha) | in Yield | increase |
| T1-18% Magnesium | 1067.42 | 375.12 | 5210 | 66.99 | 26.80 |
| Hydroxide (elemental Mg: | | | | (2.49)* | |
| 7.5%) + 38% Potassium | | | | | |
| Carbonate (elemental K: | | | | | |
| 21.35%)-WDG @ | | | | | |
| 5000 g/ha as per | | | | | |
| embodiment of the present | | | | | |
| invention | | | | | |
| T2- 18% Magnesium | 0.00 | 375.12 | 3510 | 12.50 | |
| Hydroxide (elemental Mg: | | | | (0.47) | |
| 7.5%) WDG@ 5000 g/ha | | | | | |
| T3-38% Potassium | 1067.42 | 0.00 | 3630 | 16.35 | |
| Carbonate (elemental K: | | | | (0.61) | |
| 21.35%) SG @ 5000 g/ha | | | | | |
| T4-9% Magnesium | 253.45 | 259.47 | 5050 | 61.86 | 24.33 |
| Carbonate (elemental Mg: | | | | (2.54)* | |
| 2.59%) + 5% Potassium | | | | | |
| Silicate (elemental K: | | | | | |
| 2.53%) SC @ 10000 g/ha | | | | | |
| as per embodiment of the | | | | | |
| present invention | | | | | |
| T5- 9% Magnesium | 0.00 | 259.47 | 3450 | 10.58 | |
| Carbonate (elemental Mg: | | | | (0.43) | |
| 2.59%) SC @10000 g/ha | | | | | |
| T6-5% Potassium Silicate | 253.45 | 0.00 | 3600 | 15.38 | |
| (elemental K: 2.53%) SL | | | | (0.63) | |
| @ 10000 g/ha | | | | | |
| T7- Kaymag Potassium | 1364 | 464 | 3638 | 16.60 | |
| Schoenite comprising | | | | | |
| K content 19.48% and Mg | | | | | |
| content 6.6%- | | | | | |
| commercially available | | | | | |
| powder @7000 g/ha | | | | | |
| T8-Untreated | | | 3120 | | |
| CD (at 0.5%) | | | 73.8 | | |

Synergy factor

| | | | | | Number | Mean |
|---|---|---|---|---|---|---|
| | | | | | of | Plant |
| | Nutrient concentration | | | | tillers/ | Height |
| | (mg/100 Kg of seeds) | | | | hill (60 | (cm) |
| Treatment Details | N | Fe | K | Mg | DAT) | 30DAA |
| T1-18% Magnesium Hydroxide | 480 | 350 | 1820 | 1810 | 33 | 75.50 |
| (elemental Mg: 7.5%) + 38% | | | | | | |
| Potassium Carbonate (elemental | | | | | | |
| K: 21.35%)-WDG@ 5000 g/ha as | | | | | | |
| per embodiment of the present | | | | | | |
| invention | | | | | | |
| T2- 18% Magnesium Hydroxide | 260 | 140 | 205 | 900 | 24 | 69.30 |
| (elemental Mg: 7.5%) WDG@ | | | | | | |
| 5000 g/ha | | | | | | |
| T3-38% Potassium Carbonate | 265 | 125 | 1100 | 110 | 23 | 68.20 |
| (elemental K: 21.35%) SG @ | | | | | | |
| 5000 g/ha | | | | | | |
| T4-9% Magnesium Carbonate | 470 | 370 | 1750 | 1720 | 31 | 74.50 |
| (elemental Mg: 2.59%) + 5% | | | | | | |
| Potassium Silicate (elemental K: | | | | | | |
| 2.53%) SC @ 10000 g/ha as per | | | | | | |
| embodiment of the present | | | | | | |
| invention | | | | | | |
| T5- 9% Magnesium Carbonate | 278 | 143 | 202 | 750 | 23.5 | 69.40 |
| (elemental Mg: 2.59%) SC | | | | | | |
| @10000 g/ha | | | | | | |
| T6-5% Potassium Silicate | 278 | 134 | 1020 | 100 | 24.3 | 68.70 |
| (elemental K: 2.53%) SL @ | | | | | | |
| 10000 g/ha | | | | | | |
| T7- Kaymag Potassium | 300 | 180 | 1200 | 550 | 24.5 | 70.20 |
| Schoenite comprising K content | | | | | | |
| 19.48% and Mg content 6.6%- | | | | | | |
| commercially available powder | | | | | | |
| @7000 g/ha | | | | | | |
| T8-Untreated | 250 | 120 | 200 | 120 | 19.5 | 65.0 |
| CD (at 0.5%) | — | — | — | — | — | — |

*DAA Days after Application
*The selected water insoluble Magnesium salts and water soluble Potassium salts and the concentration range of these nutrients covered in above table are exemplary and can be replaced with other water insoluble Magnesium salts and water soluble Potassium salts as per the embodiment of the present invention.

From the data observed in the Table 1, it can be seen that the compositions T1 and T4 as per the embodiments of the present invention demonstrate a synergistic behavior.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

E=X+Y−(XY)/100
Where,
E=Expected % effect by mixture of two products X and Y in a defined dose.
X=Observed % effect by product A
Y=Observed % effect by product B

The synergy factor (SF) is calculated by Abbott's formula (Eq. (2) (Abbott, 1925).

SF=Observed effect/Expected effect
Where, SF>1 for Synergistic reaction; SF<1 for antagonistic reaction; SF=1 for additive reaction.

When the percentage of yield effect observed for the combination is greater than the expected percentage, synergistic effect of the combination can be inferred. When the percentage of yield effect observed for the combination is equal to the expected percentage, merely an additive effect may be inferred and wherein the percentage of yield effect observed for the combination is lower than the expected percentage, an antagonistic effect of the combinations can be inferred.

From the data observed in Table 1, it can be concluded that the compositions T1 and T4 as per the embodiments of the present invention demonstrate synergistic behavior. This synergistic behavior of “water soluble Potassium salt with water insoluble Magnesium salt” in the form of WDG, SC as per embodiment of the present invention can be observed from the yield of the Rice crop.

Based on the data and the calculations, the expected percentage increase in the paddy crop yield was 26.80% and 24.33% for treatments T1 and T4 respectively. However, it can be clearly seen from Table 1 above that the treatment T1 with 18% Magnesium Hydroxide (elemental Mg: 7.5%)+38% Potassium Carbonate (elemental K=21.35%)—water dispersible granular composition (WDG) and Treatment T4 with 9% Magnesium Carbonate (elemental Mg: 2.59%)+5% Potassium Silicate (elemental K: 2.53%)—suspension concentrate (SC), both as per embodiment of the present invention composition showed a 66.99% and 61.86% yield increase respectively. The synergy factor is 2.49 and 2.54 for treatments T1 and T4 depicting the synergistic nature of the composition. On the other hand, treatments T2 with 18% Magnesium Hydroxide (elemental Mg: 7.5%) WDG and T3 with 38% Potassium Carbonate (elemental K: 21.35%) SG demonstrated 12.50% and 16.35% increase in the yield of paddy rice crop respectively.

Similar trends in terms of yield were also observed with the treatment T4, when compared to treatments T5, T6 respectively which also depicts the synergistic behavior of the compositions of the present invention. Treatment T5 with 9% Magnesium Carbonate (elemental Mg: 2.59%) SC and T6 with 5% Potassium Silicate (elemental K: 2.53%) SL depicted a yield of only 10.58% and 15.38% respectively. Thus, the treatments T1 and T4 with WDG, SC compositions as per the embodiments of the present invention demonstrated a synergistic effect compared to the application with individual actives.

The results are all the more surprising as the treatments T2-T3 and T5-T6 had the same dosage of Potassium salt and Magnesium salt (as that of T1 and T4) being applied to the soil at a dosage of 1067.42 g/ha of Potassium, 375.12 g/ha of Magnesium and 253.45 g/ha of Potassium, 259.47 g/ha of Magnesium respectively.

It was also observed that the leaves of rice plot treated with treatments T4 and T1 were greener as compared to Treatments T2-T3, T5-T6 and the untreated plot where yellow leaves were observed.

It can also be appreciated from the observed results that plant height and number of tillers in the Paddy crop were found to be higher in treatment T1 as compared to the individual applications of actives. On comparing treatments T2-T3 it can be noted that Treatment T1 has plant height and number of tillers of 75.50 cm and 33 respectively whereas treatments T2 and T3 have a plant height of 69.30, 68.30 cm, and 24, 23 tillers respectively. The untreated control has depicted a plant height of 65 cm, and 19.5 tillers.

Moreover, when compared to commercially available product Kaymag Potassium Schoenite-Treatment T7, the compositions of the present invention comprising a combination of water soluble Potassium salt and water insoluble Magnesium salt (T1, T4) also demonstrated superior effects despite being applied at lower dosage of application of Potassium and Magnesium. For instance: the increase in yield for treatment T7 was found to be 16.60% while number of tillers were 24.5 and plant height was 70.20 cm as compared to untreated. Further, it can be also seen with T7 that only 1200 mg and 550 mg of Potassium and Magnesium were available for uptake respectively. On the contrary, treatments T1, and T4 show much higher uptake of the same nutrients.

It can be further seen from Table 1, that treatments T1 and T4 with compositions as per the embodiment of the present invention showed a surprising uptake of nutrients like Magnesium and Potassium as compared to treatments T2-T3 and T5-T6 (where Potassium and Magnesium salts were used individually) even when these actives are applied at same dosages of application in each treatment. It can be seen that 1820 mg and 1810 mg of Potassium and Magnesium were available for uptake with respect to the WDG composition of T1 whereas only 205 mg, 1100 mg of Potassium and 900 mg, 110 mg of Magnesium were available for uptake to the plants with respect to Treatments T2 and T3 respectively.

It can also be noted that with the treatments T3 (devoid of Magnesium), the uptake of Magnesium was found to be very less, on account of high dosages of Potassium applied. Further, even when both Magnesium and Potassium were supplied together at high dosages of application, the uptake of Magnesium was found to be poor with Treatment T7 as compared to individual applications of Magnesium i.e. T2 and T5. However, it was quite surprising to observe with present compositions T1 formulated at specific formulation types with a specific combination of water soluble Potassium salt and water insoluble Magnesium salt with specific particle size and despite the supply of high dosage of Potassium, the uptake of Magnesium was found to be substantially increased, thereby also helped to overcome the Potassium induced soil antagonism with Magnesium.

This appreciable increase in the availability of nutrients especially Magnesium observed in Treatments T1, T4 vis-à-vis T2-T3, T5-T6, and T7 was noted to be on account of the nature of the composition formulated as per the embodiment of the invention i.e., in the form of water dispersible granular and aqueous suspension with particle size in the range of 0.1 microns to 30 microns which facilitated the increased availability of the entire range of nutrients present in the composition, especially Magnesium and Potassium for uptake by the crops.

The compositions of the present invention i.e. T1 and T4 also shows a significant increase in the uptake of Nitrogen and Iron which was not observed with the individual compositions and untreated i.e. T2-T3, T5-T6, and T7 in rice crop.

From the aforementioned data, it can be concluded that the composition comprising of “water soluble Potassium salt and water insoluble Magnesium salt” in the form of WDG, SC as per the embodiment of the present invention at different dosages is synergistic in nature and at covered concentration ranges demonstrated significantly higher uptake of nutrients, higher yield, plant height, and the number of tillers in paddy crop. Thus, a composition of present invention was found to be highly nutrient-use efficient.

The inventors of the present invention have further observed that apart from the Magnesium and Potassium salts listed in the Table 1 above, other Magnesium and Potassium Salts as per the present application also exhibited similar effect in terms of synergy when applied as per the embodiment of the present invention.

Experiment 2: To study the effect of WDG, SC compositions of “water insoluble Magnesium salt and water soluble Potassium salt” on Groundnut Crop.

Field trial was conducted for the evaluation of an embodiment of the composition of the present invention at Jalgaon, Maharashtra on Groundnut crop, variety BGl. The trials were laid down in Randomized Block Design (RBD) with eight treatments including untreated control, replicated four times. For each treatment, plot size of 35sq·m (7m×5m) was maintained. The test nutritional compositions with various Potassium salts, Magnesium salts alone and their combination in WDG, SC varying concentration range and salts with prescribed dose were applied as basal application at the time of sowing of Groundnut crop. The active dosage mentioned in the field experiments includes dose of elemental Potassium (K) and elemental Magnesium (Mg).

The details of the experiment are as follows:
a) Trial Location: Jalgaon, Maharashtra
b) Crop: Groundnut (BG-1)
c) Experiment season: Rabi 2023
d) Trial Design: Randomized Block Design
e) Replications: Four
f) Treatments: Eight
g) Plot size: 7m×5m=35 sq·m
h) Date of Application: Jan. 11, 2023
i) Date of sowing: Jan. 11, 2023
j) Method of application: Basal
k) Date of Harvesting: Apr. 16, 2023

The observations were recorded at the harvesting time and the mean data was presented in Table 2 to enumerate the efficacy of the WDG, SC compositions of “water insoluble Magnesium salt and water soluble Potassium salt” prepared as per the embodiment of the present invention. The nutrient uptake in groundnut seeds was also measured by analyzing in lab.

TABLE 2

| | | | Groundnut | | |
|---|---|---|---|---|---|
| | Active Ingredient | | Kernel | % | Expected |
| | (g/ha) (Elemental) | | Yield | Increase | % Yield |
| Treatment Details | K | Mg | Kg/ha | in Yield | Increase |
| T1-48% Magnesium | 202.76 | 1065.60 | 2690 | 31.22 | 11.40 |
| Phosphate (elemental | | | | (2.73)* | |
| Mg: 13.32%) + 5% | | | | | |
| Potassium Silicate | | | | | |
| (elemental K: 2.53%)-SC | | | | | |
| @ 8000 g/ha as per | | | | | |
| embodiment of the | | | | | |
| present invention | | | | | |
| T2- 48% Magnesium | 0.00 | 1065.60 | 2210 | 7.80 | |
| Phosphate (elemental | | | | (0.66) | |
| Mg: 13.32%) SC@ | | | | | |
| 8000 g/ha | | | | | |
| T3-5% Potassium | 202.76 | 0.00 | 2130 | 3.90 | |
| Silicate (elemental | | | | (0.342) | |
| K: 2.53%) SL @ | | | | | |
| 8000 g/ha | | | | | |
| T4-24% Magnesium | 522.68 | 627.48 | 2720 | 32.68 | 11.84 |
| Silicate. Hydrate | | | | (2.76)* | |
| (elemental Mg: 4.18%) + | | | | | |
| 5% Potassium Hydroxide | | | | | |
| (elemental K: 3.48%) | | | | | |
| WDG@ 15000 g/ha as | | | | | |
| per embodiment of the | | | | | |
| present invention | | | | | |
| T5- 24% Magnesium | 0.00 | 627.48 | 2200 | 7.32 | |
| Silicate hydrate | | | | (0.62) | |
| (elemental Mg: 4.18%) | | | | | |
| WDG @15000 g/ha | | | | | |
| T6- 5% Potassium | 522.68 | 0.00 | 2150 | 4.88 | |
| Hydroxide (elemental | | | | (0.41) | |
| K: 3.48%) SG @ | | | | | |
| 15000 g/ha | | | | | |
| T7- K-Mag by Mosaic | 1917 | 1100 | 2390 | 16.59 | |
| Potassium Magnesium | | | | | |
| Sulfate- | | | | | |
| Water soluble powder | | | | | |
| comprising K content of | | | | | |
| 17.43% and Mg content | | | | | |
| of 10% @11000 g/ha | | | | | |
| (Commercially available | | | | | |
| sample) | | | | | |
| T8-Untreated | | | 2050 | — | |
| CD (at 0.5%) | | | 95.8 | | |

*Synergy factor

| | | | | Mean |
|---|---|---|---|---|
| | Nutrient | | | Plant |
| | concentration | | | Branches |
| | (mg/100 Kg | | Number | (Number) |
| | of seeds) | | of pods/ | at |
| Treatment Details | K | Mg | plant | 30DAA |
| T1-48% Magnesium Phosphate | 1400 | 1300 | 29.8 | 7.20 |
| (elemental Mg: 13.32%) + | | | | |
| 5% Potassium Silicate | | | | |
| (elemental K: 2.53%)-SC | | | | |
| @ 8000 g/ha as | | | | |
| per embodiment of the | | | | |
| present invention | | | | |
| T2- 48% Magnesium Phosphate | 120 | 1050 | 23.5 | 4.00 |
| (elemental Mg: 13.32%) | | | | |
| SC@ 8000 g/ha | | | | |
| T3-5% Potassium Silicate | 1000 | 110 | 24.1 | 5.00 |
| (elemental K: 2.53%) | | | | |
| SL @ 8000 g/ha | | | | |
| T4-24% Magnesium Silicate. | 1430 | 1340 | 30.5 | 7.50 |
| Hydrate (elemental | | | | |
| Mg: 4.18%) + 5% Potassium | | | | |
| Hydroxide (elemental K: 3.48%) | | | | |
| WDG@ 15000 g/ha as per | | | | |
| embodiment of the present | | | | |
| invention | | | | |
| T5- 24% Magnesium Silicate | 130 | 1020 | 24.5 | 5.00 |
| Hydrate (elemental Mg: 4.18%) | | | | |
| WDG @15000 g/ha | | | | |
| T6- 5% Potassium Hydroxide | 1140 | 105 | 24.8 | 4.00 |
| (elemental K: 3.48%) | | | | |
| SG @ 15000 g/ha | | | | |
| T7- K-Mag by Mosaic | 1240 | 600 | 25.2 | 6.00 |
| Potassium Magnesium Sulfate- | | | | |
| Water soluble powder | | | | |
| comprising K content of | | | | |
| 17.43% and Mg content of | | | | |
| 10% @11000 g/ha | | | | |
| (Commercially | | | | |
| available sample) | | | | |
| T8-Untreated | 400 | 120 | 19.5 | 3.90 |
| CD (at 0.5%) | | | | |

*DAA Days after Application

From the data observed in the Table 2, it can be seen that the compositions T1 and T4 as per the embodiments of the present invention demonstrate a synergistic behavior in terms of groundnut kernel yield. It can be observed that the synergy factor is 2.73 and 2.76 for treatments T1 and T4 as per embodiment of the present invention from Table 2 which depicts that the SC and WDG compositions of “48% Magnesium Phosphate (elemental Mg: 13.32%)+5% Potassium Silicate (elemental K: 2.53%)”, “24% Magnesium Silicate. Hydrate (elemental Mg: 4.18%)+5% Potassium Hydroxide (elemental K: 3.48%),” are synergistic in nature.

Based on the data presented in Table 2 and the calculations made, the expected percentage increase in the groundnut kernel yield was found to be 11.40% and 11.84% with respect to the treatments T-T3 and T4-T6 respectively. However, it can be clearly seen from Table 2 above that the as per the embodiments of the present invention, treatment T4 showed a yield increase of 32.68% and treatment T1 showed a yield increase of 31.22% as compared to untreated control, depicting synergistic effect.

It was further observed that the treatments T2, T5 and T3, T6 i.e. individual applications of Magnesium and Potassium demonstrated only a 7.80%, 7.32%, 3.90% and 4.88% increase in yield as compared to compositions of the present invention i.e. T1, T4.

Further, Treatments T1 and T4 exhibited highest uptake of nutrients like Mg and K, improved plant physiological parameters like number of pods/plant and number of plant branches when compared to that of the values observed for treatments T2-T3 and T5-T6 and T7 (i.e. commercially available sample) and untreated control.

In addition to that, as compared to commercially available sample K-Mag by Mosaic Potassium Magnesium Sulfate (T7)—water soluble powder which is source of both Potassium and Magnesium, Treatments T1 and T4 exhibited superior effects in terms of yield, uptake of nutrients and growth parameters. With T7, the yield increase was only 16.59% wherein Potassium was applied at a dose of as high as 1917 g/ha and Magnesium was applied at a dose of as high as 1100 g/ha whereas with T4, the yield increase was 32.68% wherein Potassium was applied at a dose of only 522.68 g/ha and Magnesium was applied at a dose of only 627.48 g/ha which is very less dosage as compared to that of dose applied to Treatment T7.

It can also be noted that even when T7 is applied at high dosage of Magnesium in combination with high dose of Potassium, the uptake of Magnesium was found to be very low as compared to individual applications of Magnesium i.e. T2 and T5. Further, it was also observed that treatments T3 and T6 (devoid of Magnesium) also showed poor uptake of Magnesium from soil on account of high dosage of application of Potassium. On the contrary, treatments T1 and T4 i.e. present compositions with a combination of water-soluble Potassium salt and water insoluble Magnesium salt, demonstrated a significant uptake of Magnesium as compared to the rest of the treatments, especially compared to T7 which is applied at a high dosage of Magnesium. Thus, the superior effects depicted by the present compositions is on account of combination of water soluble potassium salt and water insoluble Magnesium salt formulated in WDG, SC compositions having a particle size in the range of 0.1 to 30 microns which in turn helped to overcome the soil antagonism between Potassium and Magnesium.

Experiment 3: To assess the impact of particle size distribution in the composition comprising Potassium Silicate+Magnesium Oxide-WDG, SC compositions in Soybean.

### Field Experiment Methodology:

The field trial was carried out to observe the effect of WDG, SC compositions comprising water soluble Potassium salt and water insoluble Magnesium salt in Soybean at Indore, Madhya Pradesh. The trial was laid out during Kharif season in Randomized Block Design (RBD) with eight treatments including untreated control, replicated four times. For each treatment, plot size of 30 sq·m (6m×5m) was maintained. The test product compounds Potassium salt, Magnesium salt and their combination in WDG, SC compositions as per the present invention varying concentration range with prescribed dose were applied to the soil at the time of sowing. The Soybean crop in trial field was raised following good agricultural practices.

### Details of Experiment:

a) Trial Location: Indore, Madhya Pradesh
b) Crop & Variety: Soybean (JS335)
c) Experiment season: Kharif 2023
d) Trial Design: Randomized Block Design
e) Replications:4
f) Treatments: 8
g) Plot size: 6m×5m=30sq·m
h) Date of sowing: Jul. 7, 2023
i) Date of Application: Jul. 7, 2023
j) Method of application: Soil application
k) Date of Harvesting: Oct. 10, 2023

The observations were recorded at the harvesting time and the mean data was presented in Table 3 to enumerate the efficacy of the WDG, SC compositions prepared as per the embodiment of the present invention. The nutrient uptake in soybean seeds was also measured by analyzing in lab.

TABLE 3

| | Active Ingredient | | Particle | Soybean | % |
|---|---|---|---|---|---|
| | (g/ha) (Elemental) | | size | Yield | Increase |
| Treatment Details | K | Mg | (micron) | Kg/ha | in Yield |
| T1-5% Potassium | 202.76 | 3619.20 | 0.1-30 | 2250 | 48.03 |
| Silicate (elemental K: | | | | | |
| 2.53%) + 75% | | | | | |
| Magnesium Oxide | | | | | |
| (elemental Mg: | | | | | |
| 45.24%)-WDG @ | | | | | |
| 8000 g/ha as per | | | | | |
| embodiment of the | | | | | |
| present invention | | | | | |
| T2- 4.03% Potassium | 202.76 | 3619.20 | 0.1-30 | 2235 | 47.04 |
| Carbonate (elemental K: | | | | | |
| 2.26%) + 67% | | | | | |
| Magnesium Oxide | | | | | |
| (elemental Mg: 40.42%) | | | | | |
| SC@ 8955.2 g/ha as per | | | | | |
| embodiment of the | | | | | |
| present invention | | | | | |
| T3-5% Potassium | 202.76 | 3619.20 | 31-50 | 1760 | 15.79 |
| Silicate (elemental K: | | | | | |
| 2.53%) + 75% | | | | | |
| Magnesium Oxide | | | | | |
| (elemental Mg: | | | | | |
| 45.24%)-WDG @ | | | | | |
| 8000 g/ha | | | | | |
| T4-5% Potassium | 202.76 | 3619.20 | 0.1-50 | 1800 | 18.42 |
| Silicate (elemental K: | | | | | |
| 2.53%) + 75% | | | | | |
| Magnesium Oxide | | | | | |
| (elemental Mg: | | | | | |
| 45.24%)-WDG @ | | | | | |
| 8000 g/ha | | | | | |
| T5-5% Potassium | 202.76 | 3619.20 | 0.1-100 | 1730 | 13.82 |
| Silicate (elemental K: | | | | | |
| 2.53%) + 75% | | | | | |
| Magnesium Oxide | | | | | |
| (elemental Mg: | | | | | |
| 45.24%)-WDG @ | | | | | |
| 8000 g/ha | | | | | |
| T6-5% Potassium | 202.76 | 3619.20 | 100-400 | 1620 | 6.58 |
| Silicate (elemental K: | | | | | |
| 2.53%) + 75% | | | | | |
| Magnesium Oxide | | | | | |
| (elemental Mg: | | | | | |
| 45.24%)-WDG @ | | | | | |
| 8000 g/ha | | | | | |
| T7-4% Potassium | 202.76 | 3619.20 | 0.1-100 | 1645 | 8.22 |
| Chloride (elemental K: | | | | | |
| 2.10%) + 89.847% | | | | | |
| Magnesium Hydroxide | | | | | |
| (elemental Mg: | | | | | |
| 37.45%)-Water | | | | | |
| disintegrable/ | | | | | |
| disaggregable | | | | | |
| granules @ | | | | | |
| 9664.5 g/ha with | | | | | |
| hardness of 29N | | | | | |
| (Comparative Sample) | | | | | |
| T8-Untreated | | | | 1520 | 4.61 |

| | | | | | | | Protein |
|---|---|---|---|---|---|---|---|
| | Nutrient concentration | | | | | | Content |
| | (mg/100 Kg of seeds) | | | | | | mg/kg of |
| Treatment Details | K | Mg | Zn | Cu | Mn | Ca | seeds |
| T1-5% Potassium | 1440 | 1510 | 70 | 30 | 36 | 3700 | 3, 00, 500 |
| Silicate (elemental K: | | | | | | | |
| 2.53%) + 75% | | | | | | | |
| Magnesium Oxide | | | | | | | |
| (elemental Mg: | | | | | | | |
| 45.24%)-WDG @ | | | | | | | |
| 8000 g/ha as per | | | | | | | |
| embodiment of the | | | | | | | |
| present invention | | | | | | | |
| T2- 4.03% Potassium | 1420 | 1530 | 64 | 23 | 35 | 3590 | 2, 90, 600 |
| Carbonate (elemental K: | | | | | | | |
| 2.26%) + 67% | | | | | | | |
| Magnesium Oxide | | | | | | | |
| (elemental Mg: 40.42%) | | | | | | | |
| SC@ 8955.2 g/ha as per | | | | | | | |
| embodiment of the | | | | | | | |
| present invention | | | | | | | |
| T3-5% Potassium | 1120 | 1110 | 54 | 21.9 | 23 | 2430 | 1, 30, 206 |
| Silicate (elemental K: | | | | | | | |
| 2.53%) + 75% | | | | | | | |
| Magnesium Oxide | | | | | | | |
| (elemental Mg: | | | | | | | |
| 45.24%)-WDG @ | | | | | | | |
| 8000 g/ha | | | | | | | |
| T4-5% Potassium | 1240 | 1130 | 53 | 21.4 | 24 | 2490 | 1, 45, 052 |
| Silicate (elemental K: | | | | | | | |
| 2.53%) + 75% | | | | | | | |
| Magnesium Oxide | | | | | | | |
| (elemental Mg: | | | | | | | |
| 45.24%)-WDG @ | | | | | | | |
| 8000 g/ha | | | | | | | |
| T5-5% Potassium | 1205 | 1100 | 50 | 20.2 | 23.1 | 2430 | 1, 20, 670 |
| Silicate (elemental K: | | | | | | | |
| 2.53%) + 75% | | | | | | | |
| Magnesium Oxide | | | | | | | |
| (elemental Mg: | | | | | | | |
| 45.24%)-WDG @ | | | | | | | |
| 8000 g/ha | | | | | | | |
| T6-5% Potassium | 1000 | 700 | 51 | 20.5 | 22 | 2260 | 1, 10, 873 |
| Silicate (elemental K: | | | | | | | |
| 2.53%) + 75% | | | | | | | |
| Magnesium Oxide | | | | | | | |
| (elemental Mg: | | | | | | | |
| 45.24%)-WDG @ | | | | | | | |
| 8000 g/ha | | | | | | | |
| T7-4% Potassium | 1040 | 650 | 52 | 20.3 | 22.6 | 2355 | 1, 37, 989 |
| Chloride (elemental K: | | | | | | | |
| 2.10%) + 89.847% | | | | | | | |
| Magnesium Hydroxide | | | | | | | |
| (elemental Mg: | | | | | | | |
| 37.45%)-Water | | | | | | | |
| disintegrable/ | | | | | | | |
| disagreeable | | | | | | | |
| granules @ | | | | | | | |
| 9664.5 g/ha with | | | | | | | |
| Hardness of 29N | | | | | | | |
| (Comparative Sample) | | | | | | | |
| T8-Untreated | 100 | 120 | 45 | 10 | 20.5 | 2230 | 1, 00, 000 |

Based on the data and the calculations made, it was observed that the percentage increase in the soybean yield was found to be 48.03% for treatment T1 i.e. the composition of the present invention comprising 5% Potassium Silicate (elemental K: 2.53%)+75% Magnesium Oxide (elemental Mg: 45.24%) with particle size 0.1-30 microns. Further, it can be clearly seen that the treatments T3-T6 i.e. same composition applied at same dosage of Potassium and Magnesium as that of T1 but varying particle size showed an increase in yield from 6.58% to 18.42% over untreated.

It was thus noted that the superior efficacy in terms of yield as well as protein content was observed with the water dispersible granular formulation wherein the composition comprised of particles in the size range of 0.1 micron-30 microns as compared to the same composition formulated with different particle sizes. The results are all the more surprising as all the treatments T1, T3-T6 had the same dosage of Potassium salt and Magnesium salt.

Also, upon comparing T1 with T7 i.e. water disintegrable granules (comparative sample) comprising a combination of 4% Potassium Chloride (elemental K: 2.10%)+89.847% Magnesium Hydroxide (elemental Mg: 37.45%)—with hardness of 29N formulated at 0.1 to 100 microns, there is an increase of around 40% in yield with application of treatment T1.

Similarly, a substantial increase in yield was also observed with T2, which is a suspension concentrate formulated at 0.1-30 microns i.e. compositions of the present invention as compared to T3-T7.

From Table 3, it can also be observed that there is an appreciable increase in the availability of Potassium and Magnesium along with other nutrients (trapped in soil) observed for T1, T2 than with those observed with the T3-T7 and untreated T8. Thus, the treatments T1 and T2 with particle size in the range of 0.1 microns to 30 microns also facilitated the availability of the entire range of micronutrients present in the composition for uptake by the crops.

Experiment No 4: To assess the efficacy of different formulations of “water-soluble Potassium salt with water-insoluble Magnesium salt” in commercially cultivated Wheat crop fields:

### Field Experiment Methodology:

The field trial was carried out to check the effect of WDG, SC compositions of the present invention comprising water soluble Potassium salt with water insoluble Magnesium salt in Wheat at Punjab (Malerkotla). The trial was laid out during Rabi season in Randomized Block Design (RBD) with eight treatments including untreated control, replicated four times. For each treatment, plot size of 30 sq·m (6m×5m) was maintained. The test product compounds and their combination in water dispersible granular composition as per the present invention varying concentration range with prescribed dose were applied to the soil at the time of 1^{st} irrigation of wheat (25 days after sowing). The Wheat crop in trial field was raised following good agricultural practices.

### Details of Experiment

a) Trial Location: Malerkotla, Punjab.
b) Crop: Wheat (var PBW-660)
c) Experiment season: Rabi 2022
d) Trial Design: Randomized Block Design
e) Replications: Four
f) Treatments: Eight
g) Plot size:6m×5m=30sq·m
h) Date of sowing: Oct. 12, 2022
i) Date of Application: Nov. 10, 2022
j) Method of application: Soil application
k) Date of Harvesting: Apr. 2, 2023

The observations were recorded at the harvesting time and the mean data was presented in Table 4 to enumerate the efficacy of the water dispersible granular composition and aqueous suspension composition prepared as per the embodiment of the present invention. The nutrient uptake in wheat seeds was also measured by analyzing in lab.

Herein, the same composition i.e. Magnesium Oxide+Potassium Carbonate was formulated in different formulation types such as WDG, SC, powder, pellet and water disintegrable granules and applied exactly at same active dosage of Potassium and Magnesium i.e. at 1544.95 g/ha and 995.28 g/ha to evaluate the effects of different formulation types.

TABLE 4

| | | Active Ingredient | | | % | Expected |
|---|---|---|---|---|---|---|
| | Formulation | (g/ha) (Elemental) | | Yield | Increase | % Yield |
| Treatment Details | Types | K | Mg | Kg/ha | in Yield | Increase |
| T1-30% Magnesium | WDG | 1544.95 | 995.28 | 4060 | 33.11 | 8.34 |
| Oxide (Elemental | @5500 g/ha | | | | (3.97)* | |
| Mg: 18.10%) + 50% | as per an | | | | | |
| Potassium Carbonate | embodiment | | | | | |
| (Elemental K: | of the | | | | | |
| 28.09%) | present | | | | | |
| | invention | | | | | |
| T2- 6% Magnesium | SC | 1544.95 | 995.28 | 3990 | 30.82 | |
| Oxide (Elemental | @27500 g/h | | | | (3.69)* | |
| Mg: 3.62%) + 10% | a as per an | | | | | |
| Potassium Carbonate | embodiment | | | | | |
| (Elemental K: | of the | | | | | |
| 5.62%) | present | | | | | |
| | invention | | | | | |
| T3-30% Magnesium | Water | 1544.95 | 995.28 | 3240 | 6.23 | |
| Oxide (Elemental | disintegrable | | | | (0.75) | |
| Mg: 18.10%) + 50% | Granules@ | | | | | |
| Potassium Carbonate | 5500 g/ha | | | | | |
| (Elemental K: | with | | | | | |
| 28.09%) | hardness of | | | | | |
| | 20N | | | | | |
| T4-30% Magnesium | Powder | 1544.95 | 995.28 | 3250 | 6.56 | |
| Oxide (Elemental | @5500 g/ha | | | | (0.79) | |
| Mg: 18.10%) + 50% | | | | | | |
| Potassium Carbonate | | | | | | |
| (Elemental K: | | | | | | |
| 28.09%) | | | | | | |
| T5-30% Magnesium | Pellet | 1544.95 | 995.28 | 3210 | 5.25 | |
| Oxide (Elemental | @5500 g/ha | | | | (0.63) | |
| Mg: 18.10%) + 50% | | | | | | |
| Potassium Carbonate | | | | | | |
| (Elemental K: | | | | | | |
| 28.09%) WDG | | | | | | |
| @5500 g/ha | | | | | | |
| T6-30% Magnesium | | 0.00 | 995.28 | 3170 | 3.93 | |
| Oxide (Elemental | | | | | (0.47) | |
| Mg: 18.10%) WDG | | | | | | |
| @5500 g/ha | | | | | | |
| T7-50% Potassium | | 1544.95 | 0.00 | 3190 | 4.59 | |
| Carbonate | | | | | (0.55) | |
| (Elemental K: | | | | | | |
| 28.09%) SG | | | | | | |
| @5500 g/ha | | | | | | |
| T8-Untreated | | | | 3050 | | |
| CD (at 0.5%) | | | | 75.8 | | |

*Synergy Factor

| | | Plant | Root | Nutrient concentration | | | |
|---|---|---|---|---|---|---|---|
| | No of | height | development | (mg/100 Kg of seeds) | | | |
| Treatment Details | Tillers | in cm | in cm | K | Mg | Zn | Fe |
| T1-30% Magnesium | 37 | 80.5 | 24.8 | 3600 | 75 | 43 | 70 |
| Oxide (Elemental | | | | | | | |
| Mg: 18.10%) + 50% | | | | | | | |
| Potassium Carbonate | | | | | | | |
| (Elemental K: | | | | | | | |
| 28.09%) | | | | | | | |
| T2- 6% Magnesium | 36 | 80 | 24.1 | 3480 | 72 | 40 | 68 |
| Oxide (Elemental | | | | | | | |
| Mg: 3.62%) + 10% | | | | | | | |
| Potassium Carbonate | | | | | | | |
| (Elemental K: | | | | | | | |
| 5.62%) | | | | | | | |
| T3-30% Magnesium | 29.5 | 72.6 | 14.1 | 3210 | 41.3 | 31.8 | 56.4 |
| Oxide (Elemental | | | | | | | |
| Mg: 18.10%) + 50% | | | | | | | |
| Potassium Carbonate | | | | | | | |
| (Elemental K: | | | | | | | |
| 28.09%) | | | | | | | |
| T4-30% Magnesium | 28 | 70 | 12.5 | 3240 | 41.7 | 31.6 | 56.3 |
| Oxide (Elemental | | | | | | | |
| Mg: 18.10%) + 50% | | | | | | | |
| Potassium Carbonate | | | | | | | |
| (Elemental K: | | | | | | | |
| 28.09%) | | | | | | | |
| T5-30% Magnesium | 29 | 71 | 12.3 | 3220 | 41.6 | 32.1 | 55.3 |
| Oxide (Elemental | | | | | | | |
| Mg: 18.10%) + 50% | | | | | | | |
| Potassium Carbonate | | | | | | | |
| (Elemental K: | | | | | | | |
| 28.09%) WDG | | | | | | | |
| @5500 g/ha | | | | | | | |
| T6-30% Magnesium | 28 | 70 | 11.4 | 3010 | 41.2 | 32.4 | 54.3 |
| Oxide (Elemental | | | | | | | |
| Mg: 18.10%) WDG | | | | | | | |
| @5500 g/ha | | | | | | | |
| T7-50% Potassium | 28 | 70 | 12 | 3220 | 38.4 | 33.2 | 55.3 |
| Carbonate | | | | | | | |
| (Elemental K: | | | | | | | |
| 28.09%) SG | | | | | | | |
| @5500 g/ha | | | | | | | |
| T8-Untreated | 26 | 67 | 10 | 3050 | 39.2 | 29.4 | 41.2 |

It can be clearly seen from Table 4 that the treatment T1 with 30% Magnesium Oxide (Elemental Mg: 18.10%)+50% Potassium Carbonate (Elemental K: 28.09%)—WDG and treatment T2 with 6% Magnesium Oxide (Elemental Mg: 3.62%)+10% Potassium Carbonate (Elemental K: 5.62%)—SC, both as per an embodiment of the present invention showed a yield increase of 33.11% and 30.82% in Wheat grain yield. However, treatment T3-water disintegrable granular composition, treatment T4-powder composition and treatment T5-pellet composition, all applied at the same active dosage of Potassium and Magnesium as that of the same applied for T1, demonstrated only an increase of 6.23%, 6.56% and 5.25% respectively in the grain yield.

Further, based on the data and the calculations made by referring the treatments T6-T7, the expected percentage increase in the yield was 8.34%. Thus, it can be noted that the treatments T1 and T2 demonstrated a synergistic effect, as compared to the same treatment with pellet, water disintegrable granules or with powder compositions as well as with the application of individual actives i.e. Treatments T6-T7. The results are all the more surprising as all the treatments T1 to T6 had the same dosage of Potassium and Magnesium being applied to the soil i.e. 1544.95 g/ha of Potassium and 995.28 g/ha of Magnesium.

It was further observed that treatments T1 and T2 with composition as per the embodiment of the present invention showed increased greenness and improved plant height and number of tillers, root development as compared to pellet, water disintegrable granules and powder compositions i.e. treatments T3-T5.

Moreover, it was noted that with Treatment T8-untreated, the uptake of Magnesium was observed to be 39.2 mg/kg which was remarkably reduced to 38.4 mg/kg with Treatment T7 i.e. individual application of Potassium, thus supporting the fact that Potassium inhibits the uptake of magnesium (available from the soil). However, upon comparing T1-T5 (applied at identical dosages of application Potassium and Magnesium), it was surprising to observe that despite the high dosage of application of Potassium being @1544.95 g/ha in combination with Magnesium being applied @995.28 g/ha, there is a substantial increase in the uptake of Magnesium observed with T1-T2 i.e. 75 mg/kg, 72 mg/kg of seeds of wheat respectively. On the other hand, uptake of Magnesium was substantially reduced for T3-T5 (i.e. with different formulation types) and was found to be 41.3-41.7 mg/kg of seeds. Thus, the compositions of the present invention also overcome the antagonism between Potassium and Magnesium.

It was thus noted that the composition of “water soluble Potassium salt and water insoluble Magnesium salt” in the form of WDG, SC compositions as per the embodiments of the present invention is synergistic in nature and showed a surprising enhancement in the yield as well as improved plant physiological parameters as compared to other known formulation types.

Experiment 5: To study efficacy of the composition of the present invention in WDG, SC forms on Cucumber crop.

The field trial was carried out to observe the effect of compositions of the present invention comprising water soluble Potassium salt with water insoluble Magnesium salt in Cucumber at Indore. The trial was laid out during Kharif season in Randomized Block Design (RBD) with five treatments including untreated control, replicated four times. For each treatment, plot size of 30 sq·m (6m×5m) was maintained. The compositions of the present invention in water dispersible granular and aqueous suspension form were applied foliar at pre-flowering stage. The Cucumber crop in trial field was raised following good agricultural practices.

The Details of the Experiment are as follows:
a) Trial Location: Indore, MP
b) Crop: Cucumber (Var-Malini)
c) Experiment season: Kharif 2023 (July 2023 to October 2023)
d) Trial Design: Randomized Block Design
e) Replications: 4
f) Treatments: 5
g) Plot size: 5×6=30 sq·m
h) Date of sowing: Jun. 7, 2023
i) Date of Application: Aug. 25, 2023
j) Method of application: Foliar application (Pre-flowering)
k) Date of Harvesting: Oct. 17, 2023

The observations on flowering were recorded at 40DAA and mean data of fruit yield at the time of harvest were presented in Table 5. The plant vigor observations were taken at 30 days after application at 0-200% rating scale where UTC (untreated control) should be always 100%.

TABLE 5

| | | | | | Plant | |
|---|---|---|---|---|---|---|
| | Active Ingredient | | | | vigor | Number of |
| | (g/ha) (Elemental) | | Yield | % Increase | at 30 | fruits/ |
| Treatment Details | K | Mg | Kg/ha | in Yield | days | plants |
| T1-4% Magnesium | 2000.01 | 107.37 | 11405 | 42.56 | 130 | 33.4 |
| Oxide (Elemental Mg: | | | | | | |
| 2.41%) + 80% | | | | | | |
| Potassium Carbonate | | | | | | |
| (Elemental K: | | | | | | |
| 44.95%) WDG @4450 | | | | | | |
| g/ha as per | | | | | | |
| embodiment of the | | | | | | |
| present invention | | | | | | |
| T2-5% Magnesium | 449.44 | 301.60 | 11210 | 40.13 | 125 | 32.3 |
| Oxide (Elemental Mg: | | | | | | |
| 3.02%) + 8% | | | | | | |
| Potassium Carbonate | | | | | | |
| (Elemental K: 4.49%) | | | | | | |
| SC @10000 g/ha as | | | | | | |
| per embodiment of the | | | | | | |
| present invention | | | | | | |
| T3-10% Magnesium | — | 904.80 | 8500 | 6.25 | 105 | 22.6 |
| Oxide (Elemental | | | | | | |
| Mg: 6.03%) @15000 | | | | | | |
| g/ha | | | | | | |
| T4-50% Potassium | 2809.00 | — | 9100 | 13.75 | 110 | 23.5 |
| Carbonate (Elemental | | | | | | |
| K: 28.09%) SC | | | | | | |
| @10000 g/ha | | | | | | |
| T5-Untreated | — | — | 8000 | — | 100 | 20.5 |
| CD (0.5%) | — | — | 650 | — | — | — |

From the table 5, it could be seen that the percentage yield of the cucumber crop upon application of treatments T1 and T2 i.e. the WDG, SC compositions as per the embodiment of the present invention has been increased by 40-42% with respect to the untreated control. The Plant vigor has also increased by 25-30% and number of fruits per plant has also significantly increased compared to untreated. This is an indicative of the superior nature compositions of the invention comprising a combination of water-soluble Potassium salt and water insoluble Magnesium salt.

It was further noted from the above data that the composition of treatments T1 and T2 although applied at reduced dosage of application when compared to the individual compositions i.e. T3 and T4, was found to be superior in terms of yield increase, plant vigor and number of fruits per plant. The treatments T3 and T4 shows a yield increase of only 6.25% and 13.75% against untreated.

From the aforementioned data, it can be concluded that the composition comprising of “water soluble Potassium salt and water insoluble Magnesium salt” in the form of WDG, SC as per the embodiment of the present invention demonstrated the enhanced effects over the entire concentration range covered and varying the water-soluble Potassium salt and water insoluble Magnesium salt, even when applied at reduced dosage of application as that of individual actives.

Experiment No. 6: To study the effect of composition comprising a combination of different types of Potassium Salt and Magnesium Salts on Tomato Crop:

The experimental site was selected based on tomato crops where the nutrient deficiency symptoms were likely to occur, where the soil nutrient content was below the deficit level.

The trial was laid out during Kharif season in Randomized Block Design (RBD) with nine treatments including untreated control, replicated four times. For each treatment, plot size of 40 sq·m (8m×5m) was maintained. The compositions evaluated include Potassium salt, Magnesium salt alone and different formulations including combinations of Potassium salt with Magnesium salt. The Tomato crop in the trial field was raised following good agricultural practices. The seeds of Tomato, Abhilash, were used for the study and planted in 120 cm row-to-row and 45 cm plant to plant spacing. The details of the experiment are as follows:

### Details of Experiment

a) Trial Location: Nasik (MH)
b) Crop: Tomato (variety Abhilash)
c) Experiment season: Kharif 2023
d) Trial Design: Randomized Block Design
e) Replications: Four
f) Treatments: Nine
g) Plot size: 8m×5m=40 sq·m
h) Date of Application: Jul. 17, 2022
i) Method of application: Bend/side placement
j) Date of transplanting: Jul. 17, 2022
k) Date of Pickings: Oct. 30, 2022, Oct. 10, 2022, Nov. 15, 2022

The observations on fruit selling were carried out by tagging newly opened blossoms once a week, and counting the number of tagged blossoms which set fruits one week later. The fruits were harvested six times and weighed each time.

Herein the inventors have tested various combinations of salts of Potassium and Magnesium and the mean data of all the observations were presented in Table 6 to illustrate the impact of combination of water soluble salt of Potassium with water insoluble salt of Magnesium in the form of compositions of the present invention on Tomato yield, fruit weight and other parameters.

TABLE 6

| | | Active Ingredient | | | | Expected |
|---|---|---|---|---|---|---|
| | | (g/ha) (Elemental) | | Yield | % Increase | % Yield |
| Treatment Details | | K | Mg | Kg/ha | in Yield | Increase |
| T1-7.2% Magnesium | Combination | 448.90 | 435.17 | 27900 | 38.81 | 15.74 |
| Oxide (Elemental Mg: | of water | | | | (2.46)* | |
| 4.34%) + 25% Leucite | insoluble | | | | | |
| (Elemental K: 4.48%)- | Mg salt and | | | | | |
| WDG@ 10020 g/ha as | water | | | | | |
| per embodiment of the | soluble K | | | | | |
| present invention | salt | | | | | |
| T2-24.8% Magnesium | Combination | 448.90 | 436.61 | 22300 | 10.95 | |
| Sulphate heptahydrate | of Water | | | | (0.70) | |
| (Elemental Mg: | soluble Mg | | | | | |
| 4.36%) + 25% Leucite | salt and | | | | | |
| (Elemental K: 4.48%)- | Water | | | | | |
| SG @ 10020 g/ha- | soluble K | | | | | |
| Comparative Sample | salt | | | | | |
| T3-7.2% Magnesium | Combination | 448.90 | 435.85 | 22570 | 12.29 | |
| Oxide (Elemental Mg: | of Water | | | | (0.78) | |
| 4.34%) + 30% | insoluble | | | | | |
| Feldspar (Elemental | Mg salt and | | | | | |
| K: 4.47%)- WDG | Water | | | | | |
| @10035.7 g/ha - | insoluble K | | | | | |
| Comparative Sample | salt | | | | | |
| T4-24.8% Magnesium | Combination | 448.90 | 437.29 | 22237 | 10.63 | |
| Sulphate heptahydrate | of Water | | | | (0.68) | |
| (Elemental Mg: | soluble Mg | | | | | |
| 4.36%) + 30% | salt and | | | | | |
| Feldspar (Elemental | Water | | | | | |
| K: 4.47%)-WDG | insoluble K | | | | | |
| @10035.7 g/ha- | salt | | | | | |
| Comparative Sample | | | | | | |
| T5-7% Magnesium | Combination | 447.44 | 436.26 | 27300 | 35.82 | |
| Oxalate (Elemental | of Water | | | | (2.28)* | |
| Mg: 1.51%) + 8% | insoluble | | | | | |
| Potassium Schoenite | Mg salt and | | | | | |
| (Elemental K: 1.55%) | Water | | | | | |
| SC composition | soluble K | | | | | |
| @28800 g/ha as per | salt | | | | | |
| embodiment of the | | | | | | |
| present invention | | | | | | |
| T6-39.4% Magnesium | Combination | 449.01 | 436.12 | 22500 | 11.94 | |
| Sulphate Heptahydrate | of water | | | | (0.76) | |
| (Elemental Mg: | soluble Mg | | | | | |
| 6.92%) + 36.7% | salt and | | | | | |
| Potassium Schoenite | water | | | | | |
| (Elemental K: 7.13%) - | soluble K | | | | | |
| SL @6300 g/ha | salt | | | | | |
| composition- | | | | | | |
| Comparative Sample | | | | | | |
| T7- 34% Magnesium | — | 0.00 | 435.57 | 21700 | 7.96 | |
| Oxalate (Elemental | | | | | (0.51) | |
| Mg: 7.36%) WDG | | | | | | |
| @5920 g/ha | | | | | | |
| T8-39% Potassium | — | 448.97 | 0.00 | 21800 | 8.46 | |
| Schoenite (Elemental | | | | | (0.54) | |
| K: 7.57%) SG | | | | | | |
| @5928 g/ha | | | | | | |
| T9-Untreated | — | 0 | 0 | 20100 | | |
| CD (0.5%) | | | | 115.8 | | |

| | | | Mean |
|---|---|---|---|
| | | Tomato | number |
| | | fruit | of flowers |
| | | weight | per plant |
| Treatment Details | | (g) | at 45 days |
| T1-7.2% Magnesium Oxide (Elemental | Combination of | 81 | 47.20 |
| Mg: 4.34%) + 25% Leucite (Elemental | water insoluble Mg | | |
| K: 4.48%)-WDG @ 10020 g/ha as per | salt and water | | |
| embodiment of the present invention | soluble K salt | | |
| T2-24.8% Magnesium Sulphate | Combination of | 71.2 | 40.20 |
| heptahydrate (Elemental Mg: 4.36%) + | Water soluble Mg | | |
| 25% Leucite (Elemental K: 4.48%)- SG | salt and Water | | |
| @ 10020 g/ha-Comparative Sample | soluble K salt | | |
| T3-7.2% Magnesium Oxide (Elemental | Combination of | 70.4 | 40.30 |
| Mg: 4.34%) + 30% Feldspar (Elemental | Water insoluble | | |
| K: 4.47%)- WDG @10035.7 g/ha - | Mg salt and Water | | |
| Comparative Sample | insoluble K salt | | |
| T4-24.8% Magnesium Sulphate | Combination of | 71.8 | 41.10 |
| (Elemental Mg: 4.36%) + 30% Feldspar | Water soluble Mg | | |
| (Elemental K: 4.47%)-WDG @10035.7 | salt and Water | | |
| g/ha- Comparative Sample | insoluble K salt | | |
| T5-7% Magnesium Oxalate (Elemental | Combination of | 79.9 | 46.30 |
| Mg: 1.51%) + 8% Potassium Schoenite | Water insoluble | | |
| (Elemental K: 1.55%) SC composition | Mg salt and Water | | |
| @28800 g/ha as per embodiment of the | soluble K salt | | |
| present invention | | | |
| T6-39.4% Magnesium Sulphate | Combination of | 70.2 | 40.20 |
| Heptahydrate (Elemental Mg: 6.92%) + | water soluble Mg | | |
| 36.7% Potassium Schoenite (Elemental | salt and water | | |
| K: 7.13%) - SL @6300 g/ha | soluble K salt | | |
| composition- Comparative Sample | | | |
| T7- 34% Magnesium Oxalate | — | 69.3 | 39.30 |
| (Elemental Mg: 7.36%) WDG | | | |
| @5920 g/ha | | | |
| T8-39% Potassium Schoenite | — | 68.7 | 38.20 |
| (Elemental K: 7.57%) SG @5928 g/ha | | | |
| T9-Untreated | — | 65.2 | 36.4 |
| CD (0.5%) | | | |

It can be seen from the data presented in Table 6 that the compositions of the present invention i.e. T1 and T5 with a combination of water-soluble Potassium (K) salt and water insoluble Magnesium (Mg) salt illustrated significant increase in yield, fruit weight and number of flowers per plant as compared to other treatments as shown in the table i.e. T2-T4 and T6. In particular, upon comparing T1-T4 which were applied at almost same dosage of Potassium and Magnesium salt and in same granular formulation, the treatment T1 with water soluble K salt and water insoluble Mg salt shows enhanced increased in yield of around 38% while treatment T2 with combination of water soluble Mg salt and water soluble K salt, treatment T3 with combination of water insoluble Mg salt and water insoluble K salt and treatment T4 with combination of water soluble Mg salt and water insoluble K salt shows a yield increase of around 10-12%.

This unexpected and surprising increase in yield was on account of the combination of water soluble K salt and water insoluble Mg salt and was not observed with other combinations i.e. water soluble Mg salt and water soluble K salt, water insoluble Mg salt and water insoluble K salt and water soluble Mg salt and water insoluble K salt. etc. The same trend was observed in case of Tomato fruit weight; wherein the expected fruit weight was 11.32% while treatment T1 shows 24.23% increase while T2-T4 depicts around 7-10% increase in yield, demonstrating a synergistic nature of the present invention.

Similarly, treatment T5 which is a suspension concentrate formulation comprising a combination of water soluble K salt and water insoluble Mg salt illustrated a yield increase of 35.82% and fruit weight increase of 22.55% when compared to the combination of water soluble K salt and water soluble Mg Salt in liquid formulation i.e. treatment T6 which was showing an increase of 11.94% and 7.67% in yield and fruit weight as compared to untreated respectively.

Experiment No. 7: To study the effect of the composition of the present invention in comparison to traditional fertilizer practices.

The field trials were carried out to observe the effect of the composition of the present invention in the form of WDG on the availability of Magnesium, Potassium along with Nitrogen and Phosphorous with that of the application of traditional fertilizer practices over a period of time on Onion Crop at Junagadh (Gujarat) (India).

The trials were laid down in Randomized Block Design (RBD) with the treatments indicated below including untreated control, replicated seven times. For each treatment, plot size of 40sq·m (8m×5m) was maintained.

The planted onion seedlings were raised with GAP (Good Agricultural Practice) until harvesting or full development of Onion bulb.

The Details of the Experiment are as follows:
a) Trial Location: Junagardh, Gujarat
b) Crop: Onion (var. Red Onion-11)
Experiment season: Rabi 2022-2023
d) Trial Design: Randomized Block Design
e) Replications: 13
f) Treatments: 4
g) Plot size:8m×5m=40 sq·m
h) Date of Application: Nov. 22, 2022
i) Date of seedling planting: Nov. 22, 2022
j) Method of application: Basal (Soil Application)
k) Date of Harvesting: Feb. 2, 2023

The observations on uptake on nutrients were recorded and mean data was presented in Tables 7A, 7B to enumerate the availability of Magnesium, Potassium along with Nitrogen and Phosphorous.

Table 7A: Tests were performed to assess the yield and nutrient availability with the application of traditional fertilizer practices.

NPK Traditional fertilizer 19:19:19 (Treatment T1) was applied at the time of transplanting onion seedlings, thereafter Kaymag Potassium Schoenite-commercially available Potassium—Magnesium source (Treatment T2) was applied after an interval of 45 days.

The mean values were calculated and presented as below.

| | | Nutrient | | | |
|---|---|---|---|---|---|
| | | content in | | | |
| | Onion Bulb | Onion bulb | | | |
| | weight in | (ppm) at | NPK in leaves (ppm) | | |
| | g/bulb at | harvest | at 60 days of application | | |
| Treatment Details | harvest | Mg | N | P | K |
| T1-NPK Traditional | 48.4 | 130 | 400 | 300 | 400 |
| fertilizer 19:19:19 | | | | | |
| applied @ formulation | | | | | |
| dosage of 10,000 g/ha | | | | | |
| followed by | | | | | |
| T2- Kaymag Potassium | | | | | |
| Schoenite comprising K | | | | | |
| content 19.48% and Mg | | | | | |
| content 6.6%- | | | | | |
| commercially available | | | | | |
| powder @active dose | | | | | |
| of 959 g/ha of K and | | | | | |
| 550 g/ha of Mg applied | | | | | |
| @ formulation dosage | | | | | |
| of 5,500 g/ha | | | | | |
| T3-Untreated | 45.2 | 80 | 300 | 100 | 320 |

Table 7B: Tests were performed to assess the yield and nutrient availability with the application of the composition as per the embodiment of the present invention.

NPK Traditional fertilizer 19:19:19 (Treatment T1) was applied at the time of transplanting onion seedlings, thereafter a WDG composition as per embodiment of the present invention (Treatment T2) was applied after an interval of 45 days.

The mean values were calculated and presented as below.

| | | Nutrient | | | |
|---|---|---|---|---|---|
| | | content | | | |
| | Onion Bulb | in Onion | | | |
| | weight in | bulb (ppm) | NPK in leaves (ppm) | | |
| | g/bulb at | at harvest | at 60 days of application | | |
| Treatment Details | harvest | Mg | N | P | K |
| T1-NPK Traditional | 53.6 | 200 | 500 | 400 | 480 |
| fertilizer 19:19:19 | | | | | |
| applied @ formulation | | | | | |
| dosage of 5,000 g/ha | | | | | |
| followed by | | | | | |
| T2-55% Potassium | | | | | |
| Schoenite (elemental | | | | | |
| K: 10.68%) applied | | | | | |
| @ active dose of | | | | | |
| 534.05 g/ha and 35% | | | | | |
| Magnesium Carbonate | | | | | |
| (elemental Mg: 10.09%) | | | | | |
| @active dose of | | | | | |
| 504.53 g/ha-WDG as | | | | | |
| per embodiment of | | | | | |
| the present invention | | | | | |
| applied @ formulation | | | | | |
| dose of 5,000 g/ha | | | | | |
| T3-Untreated | 45.2 | 80 | 300 | 100 | 320 |

It can be seen from Table 7A that the treatments T1 i.e. traditional NPK practice followed by T2 i.e. commercially available K—Mg product were applied at a high dosage of 10 Kg/ha and 5.5 Kg/ha respectively and still the plant has shown very poor uptake of not only Magnesium and Potassium but also primary nutrients such as Nitrogen and Phosphorous as compared to untreated.

It was thus observed that the traditional practice of application of NPK and other treatments even at higher dosage of application did not meet the nutritional requirement of the plant and failed to provide even an adequate uptake of Magnesium, Potassium and primary nutrients like Nitrogen and Phosphorous.

It can be further seen from Table 7B that despite the dosage of traditional NPK fertilizer was reduced to half, the said treatment followed by the composition as per the embodiment of the present invention when applied to crops, has surprisingly shown significant increase in the uptake of not only Magnesium and Potassium but also primary nutrients such as Nitrogen and Phosphorous and also the yield as compared to untreated.

Thus, the present composition not only helps to increase the uptake of nutrients like nitrogen which was not observed with the application of traditional NPK fertilizers despite being applied at high dosage but also helps to reduce the dosage of traditional NPK fertilizers, thus depicting the high nutrient use efficiency of the composition.

Experiment No. 8: To study the effect of the composition of the present compositions on the yield and growth parameters on Brinjal Crop.

The trial was laid out during Kharif season in Randomized Block Design (RBD) with eight treatments including untreated control, replicated four times. For each treatment, plot size of 40 sq·m (8m×5m) was maintained. The compositions evaluated include water insoluble Mg salt and water soluble K salt and Molybdenum salt in combination and alone. The Brinjal crop in the trial field was raised following good agricultural practices. The seeds of Brinjal, Pusa purple long, were used for the study and planted in 120 cm row to row and 45 cm plant to plant spacing. The details of the experiment are as follows:

### Details of Experiment

Trial location:Nasik (MH)
Crop: Brinjal, (Pusa purple long)
Experiment season Kharif
Trial Design:Randomized Block Design
Replications:Five
Plot size:8m×5m=40 sq·m
Type of application:Drip irrigation
Water volume used: 500 L/ha
Date of transplanting:Jul. 30, 2022
Date of application:Aug. 30, 2022 (one application)
Date of Pickings:Dec. 12, 2011, Nov. 23, 2022, Nov. 15, 2022

The plant vigor observations were taken at 50 days after application at 0-200% rating scale where UTC (untreated control) should be always 100%. The observations on yield were recorded at the time of harvesting and mean data is presented in Table 8.

TABLE 8

| | | | | No. | Plant | Yield | |
|---|---|---|---|---|---|---|---|
| | | | | of | vigor | (T/ha) | |
| | Active dosage | | | Fruits | (0-200) | Total | |
| | (Elemental) (g/ha) | | | per | at | of 3 | % yield |
| Treatment Details | K | Mg | Mo | plant | 50DAA | pickings | increase |
| T1-27% Magnesium | 836.39 | 618.95 | 3.13 | 15 | 150 | 9.3 | 43.08 |
| Hydroxide | | | | | | | |
| (elemental Mg: | | | | | | | |
| 11.25%) + 30% | | | | | | | |
| Potassium Silicate | | | | | | | |
| (elemental | | | | | | | |
| K: 15.21%) + 0.095% | | | | | | | |
| Molybdenum | | | | | | | |
| Disulfide (elemental | | | | | | | |
| Mo: 0.057%)-WDG | | | | | | | |
| @ 5500 g/ha as per | | | | | | | |
| embodiment of the | | | | | | | |
| present invention | | | | | | | |
| T2- 27% Magnesium | 836.39 | 0 | 0 | 10 | 113 | 7.5 | 15.38 |
| Hydroxide | | | | | | | |
| (elemental Mg: | | | | | | | |
| 11.25%) WDG@ | | | | | | | |
| 5500 g/ha | | | | | | | |
| T3-30% Potassium | 0 | 618.95 | 0 | 10 | 110 | 7.0 | 7.69 |
| Silicate (elemental | | | | | | | |
| K: 15.21%) SG @ | | | | | | | |
| 5500 g/ha | | | | | | | |
| T4- 0.095% | 0 | 0 | 3.13 | 8 | 105 | 6.6 | 1.54 |
| Molybdenum | | | | | | | |
| Disulfide (elemental | | | | | | | |
| Mo: 0.057%)- | | | | | | | |
| WDG@ 5500 g/ha | | | | | | | |
| T5: Untreated | 0 | 0 | 0 | 8 | 100 | 6.5 | 0.00 |

It can be observed from Table 8 that Treatment T1 with WDG composition of “27% Magnesium Hydroxide (elemental Mg: 11.25%)+30% Potassium Silicate (elemental K: 15.21%)+0.095% Molybdenum Disulfide (elemental Mo: 0.057%)—WDG” as per embodiment of the present invention, was highly effective and demonstrated increased yield of Brinjal as compared to the individual treatments of the actives (T2, T3 and T4). It can be seen that the treatments T1 to T4 were applied at same active dosage i.e. 836.39 g/ha of Potassium, 618.95 g/ha of Magnesium and 3.3 g/ha of Molybdenum. The observed % increase in yield for T1 is 43.08% while the observed % increase in yield for T2-T4 is 15.38%, 7.69% and 6.6% respectively.

It can be appreciated from the observed results that the number of fruits per plant and plant vigor in the brinjal crop were higher in treatment T1 as compared to the individual treatments of the actives. It was also observed that other plant growth parameters such as plant height, number of branches, greenness the leaves of brinjal plot treated with treatments T1 were superior as compared to Treatments T2-T4 and the untreated plot where yellow leaves, stunted plant growth were observed.

Thus, the treatment T1 as per embodiment of the present invention is synergistic and provides higher crop yield and improved growth parameters as compared to the application of individual actives when applied at the same dosage. It was further noted that the presence of Molybdenum in addition to water insoluble Magnesium salt and water soluble Potassium salt in the composition of the present invention imparts additional advantages when applied to the crops.

Further, the inventors of the present invention also tested the WDG, SC composition of the present invention on other crops like Chili, Maize. It was observed that the composition of the present invention may further enhance crop yield and crop characteristics like straw weight, oil content, greenness of crop, fruit weight, improved photosynthesis, increase chlorophyll content, plant height and also add to nutritional value of the crop.

Since water soluble Potassium salt tends to leach away, it was expected that the present composition would not provide the desired efficacy when applied to fields. Further, on account of the use of water soluble salt of Potassium, it was expected that the present composition would provide Potassium more rapidly than that of Magnesium and thus would result in poor uptake of Magnesium by the plants in view of K—Mg antagonism in the soil. However, it was surprising to observe that the present composition not only demonstrates the enhanced effects in terms of crop yield but also in terms of uptake of Mg and K, demonstrating synergistic effects.

It is thus observed that the superior effect of the present composition is on account of combination of elements being a combination of water soluble K salt and water insoluble Mg salt formulated in WDG, SC compositions and having a particle size of 0.1-30 microns.

It has been observed that the composition of the present invention, demonstrates enhanced, efficacious and superior behavior in the fields. Through the composition of the present invention, the number of applications or the amount of nutrients, fertilizers or pesticides are minimized. Moreover, the present composition exhibits a surprisingly higher field efficacy at reduced dosages of application of the composition as compared to prior known composition. The composition is highly safe for the user and for the environment. This novel composition helps to improve plant yield, balanced uptake of all nutrients, reduce yellowing of leaves and plant physiological parameters providing a nutritionally rich crop.

Further, the various advantageous properties associated with the compositions according to the invention, include but are not limited to improved stability, improved toxicological and/or ecotoxicological behavior, improved crop characteristics including crop yields, crop qualities and characteristics and other advantages familiar to a person skilled in the art.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

I Claim:

1. A crop nutrition composition comprising:
(i) one or more of water insoluble Magnesium salts or derivatives thereof,
(ii) one or more of water soluble Potassium salts or derivatives thereof,
(iii) one or more of surfactants,
wherein the composition is in the form of water dispersible granules or aqueous suspension; and
wherein the composition has elemental Magnesium content in the range of 1% to 50% by weight of the total composition and
wherein the composition has elemental Potassium content in the range of 1% to 50% by weight of the total composition, and
wherein the surfactant is in the range of 0.1 to 40% by weight of the total composition, and
wherein the composition comprises particles in the size range of 0.1 micron-30 microns.

2. The crop nutrition composition as claimed in claim 1, wherein water insoluble Magnesium salt or derivative is selected from one or more of Magnesium Molybdate, Magnesium Hydroxide, Calcium Magnesium Phosphate, Magnesium Phosphate, Magnesium Humate, Magnesium Carbonate, Magnesium Aluminium Silicate, Calcium Magnesium Silicate, Magnesium Tartrate, Magnesium Trisilicate, Magnesium Oxalate, Magnesium Fulvate, Magnesium Silicate, Magnesium Oxide, Periclase, Brucite and Magnesite.

3. The composition as claimed in claim 1, wherein Potassium salt or derivative is selected from one or more of Potassium Carbonate, Potassium Selenide, Potassium Sulfate, Potassium Silicate, Potassium Bicarbonate, Potassium Persulfate, Potassium Hydroxide, Potassium Schoenite, Potassium Humate, Camallite, Picromerite, Glauconite, Biotite, and Langbeinite.

4. The crop nutrition composition as claimed in claim 1, wherein the surfactant comprises one or more of anionic and non-ionic surfactants.

5. The crop nutrition composition as claimed in claim 1, wherein the surfactant comprises one or more of emulsifiers, wetting agents and dispersing agents.

6. The crop nutrition composition as claimed in claim 5, wherein the dispersing agent is a non-ionic dispersant selected from one or more of polyvinyl pyrrolidone, polyvinyl alcohol, polyoxyethylene alkyl ethers, polyoxyethylene alkyl phenyl ether, ethoxylated fatty acids, aliphatic alcohol ethoxylates, alkyl ethoxylates; EO-PO block copolymers, graft copolymers, addition products of ethylene oxide and fatty acid esters, Kraft lignin polymer, polyoxyethylene alkyl esters, polyoxyethylenesorbitan alkyl esters, ethoxylated alkyl phenols, polyoxyethylenestyryl phenyl ether.

7. The crop nutrition composition as claimed in claim 5, wherein the dispersing agent is anionic dispersant selected from one or more of sulfated fatty alcohol glyscol ethers, tristyrylphenolethoxylate phosphate esters; lignin sulphonates, phenyl naphthalene sulphonates, alkali metal, alkaline earth metal and ammonium salts of lignosulfonic acid, lignin derivatives, alkylarylsulfonates, alkylsulfonates, mixture of sodium salt of naphthalene sulphonic acid urea formaldehyde condensate and sodium salt of phenol sulphonic formaldehyde condensate, polycarboxylates, sodium alkyl benzene sulfonates, sodium salts of sulfonated naphthalene, sodium naphthalene sulfonate formaldehyde condensates, condensation products of aryl sulphonic acids and formaldehyde, polyaromatic sulfonates, sodium alkyl aryl sulfonate.

8. The crop nutrition composition as claimed in claim 1, wherein the composition further comprises one or more of agrochemically acceptable excipient selected from one or more of fillers or carriers or diluents, spreading agents, colorants, anticaking agents, disintegrating agents, binders, buffers or pH adjusters or neutralizing agents, pigments, stabilizers, antifoaming agents or defoamers, penetrants, ultraviolet absorbents, structuring agents, humectants, sticking agents, anti-freezing agent or freeze point depressants, chelating or complexing or sequestering agents preservatives or bactericides or anti-fungal agents or biocides or anti-microbial agents or antioxidants.

9. The crop nutrition composition as claimed in claim 1, wherein aqueous suspension composition further comprises structuring agent selected from one or more of thickeners, suspending agents or suspension aid agents, viscosity modifiers or rheology modifiers, tackifiers and anti-settling agents.

10. The crop nutrition composition as claimed in claim 9, wherein the structuring agent is present in the range of 0.01 to 20% w/w of the total composition.

11. The crop nutrition composition as claimed in claim 1, wherein the water dispersible granular composition has a dispersibility of at least 30%.

12. The crop nutrition composition as claimed in claim 1, wherein the composition has a suspensibility of at least 30%.

13. The crop nutrition composition as claimed in claim 1, wherein the aqueous suspension composition has a viscosity of 150 cps to 2000 cps at 25 °C.

14. The crop nutrition composition as claimed in claim 1, wherein the composition further comprises elemental Molybdenum, or its salts, or derivatives or mixtures thereof; and wherein the composition has elemental Molybdenum content in the range of 0.001 to 10% by weight of the total composition.

15. A process for preparation of the crop nutrition composition in the form of water dispersible granules as claimed in claim 1, wherein the process comprises:
A. milling:
i. one or more of water insoluble Magnesium salts or derivatives thereof,
ii. one or more of water soluble Potassium salts or derivatives thereof,
iii. one or more of surfactants, in water to obtain a slurry or wet mix,
B. drying the slurry or wet mix to obtain the granules;
wherein the composition has elemental Magnesium content in the range of 1% to 50% by weight of the total composition, and
wherein the composition has elemental Potassium content in the range of T % to 50% by weight of the total composition, and
wherein the surfactant is in the range of 0.1 to 40% by weight of the total composition, and
wherein the composition comprises particles in the size range of 0.1 micron-30 microns.

16. A process for preparation of the crop nutrition composition in the form of aqueous suspension as claimed in claim 1, wherein the process comprises: milling:
i. one or more of water insoluble Magnesium salts or derivatives thereof,
ii. one or more of water soluble Potassium salts or derivatives thereof,
iii. one or more of surfactants,
in water to obtain a homogeneous suspension with a particle size range of 0.1 micron to 30 microns,
wherein the composition has elemental Magnesium content in the range of 1% to 50% by weight of the total composition and
wherein the composition has elemental Potassium content in the range of 1% to 50% by weight of the total composition, and
wherein the surfactant is in the range of 0.1 to 40% by weight of the total composition.

17. A crop nutrition composition as claimed in claim 1, wherein the composition is at least one of a fertilizer composition, a nutrient composition, a crop strengthener composition, a soil conditioner composition and a yield enhancer composition.

18. A method for improving plant health or yield, wherein the method comprises treating at least one of a plant, a plant propagation material, locus or plant parts thereof, a seed, seedling or surrounding soil with the crop nutrition composition as claimed in claim 1.

19. A method for treating plants and meeting their nutritional requirement by enhancing uptake of Magnesium and Potassium by application of crop nutrition composition comprising:
i. one or more of water insoluble Magnesium salts or derivatives thereof,
ii. one or more of water soluble Potassium salts or derivatives thereof,
iii. one or more of surfactants,
wherein the composition is in the form of water dispersible granules or aqueous suspension; and
wherein the composition has elemental Magnesium content in the range of 1% to 50% by weight of the total composition, and
wherein the composition has elemental Potassium content in the range of 1% to 50% by weight of the total composition, and
wherein the surfactant is in the range of 0.1 to 40% by weight of the total composition, and
wherein the composition comprises particles in the size range of 0.1 micron-30 microns.
